(19) United States
(12) Patent Application Publication
(10) Pub. No.: US 2010/0169311 A1
(43) Pub. Date: Jul. 1, 2010

(54) APPROACHES FOR THE UNSUPERVISED CREATION OF STRUCTURAL TEMPLATES FOR ELECTRONIC DOCUMENTS

(76) Inventors: ASHWIN TENGLI, Bangalore (IN); Aravindan Raghuveer, Bangalore (IN); Krishna Prasad Chitrapura, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/346,483

(22) Filed: Dec. 30, 2008

(51) Int. Cl. G06F 7/06; G06F 17/30

(52) U.S. Cl. 707/736; 707/E17.108

(57) ABSTRACT

A method and apparatus for creating templates for electronic documents is provided. One or more attributes are extracted, using a seed template, from a first document, such as a web page. A second document that contains a particular attribute, extracted from the first document, is identified. The second document may be in a different cluster than the first document. The second document is annotated, using an extracted attribute, to create an annotated document. The second document is annotated without human intervention. A new template for the annotated document is generated. The new template facilitates extraction of information from the annotated document. The new template may be used to extract additional attributes from all documents in the cluster of documents of which the second document is a member. The process may continue over numerous iterations to generate a large number of templates in an automated fashion.

### CROSS REFERENCE TO RELATED APPLICATIONS

This application is related to U.S. patent application Ser. No. 11/481,809, filed on Jul. 5, 2006, entitled “TECHNIQUES FOR CLUSTERING STRUCTURALLY SIMILAR WEB PAGES BASED ON PAGE FEATURES”, the entire content of which is incorporated by reference for all purposes as if fully disclosed herein.

This application is also related to U.S. patent application Ser. No. 11/481,734, filed on Jul. 5, 2006, entitled “TECHNIQUES FOR CLUSTERING STRUCTURALLY SIMILAR WEB PAGES”, the entire content of which is incorporated by reference for all purposes as if fully disclosed herein.

This application is also related to U.S. patent application Ser. No. 11/838,351, filed on Aug. 14, 2007, entitled “METHOD FOR ORGANIZING STRUCTURALLY SIMILAR WEB PAGES FROM A WEB SITE”, the entire content of which is incorporated by reference for all purposes as if fully disclosed herein.

This application is also related to U.S. patent application Ser. No. 11/945,749, filed on Nov. 27, 2007, entitled “TECHNIQUES FOR INDUCING HIGH QUALITY STRUCTURAL TEMPLATES FOR ELECTRONIC DOCUMENTS”, the entire content of which is incorporated by reference for all purposes as if fully disclosed herein.

This application is also related to U.S. patent application Ser. No. 11/938,736, filed on Nov. 12, 2007, entitled “TECHNIQUES FOR INDUCING HIGH QUALITY STRUCTURAL TEMPLATES FOR ELECTRONIC DOCUMENTS”, the entire content of which is incorporated by reference for all purposes as if fully disclosed herein.

### FIELD OF THE INVENTION

The present invention relates to computer networks and, more particularly, to techniques for automatically creating templates that are used in extracting information from documents.

### BACKGROUND OF THE INVENTION

### World Wide Web-General

The Internet is a worldwide system of computer networks and is a public, self-sustaining facility that is accessible to tens of millions of people worldwide. The most widely used part of the Internet is the World Wide Web, often abbreviated “WWW” or simply referred to as just “the web.” The web is an Internet service that organizes information through the use of hypermedia. The HyperText Markup Language (“HTML”) is typically used to specify the contents and format of a hypermedia document (e.g., a web page).

In this context, an HTML file is a file that contains source code for a particular web page. Typically, an HTML document includes one or more pre-defined HTML tags and their properties, and text enclosed between the tags. A web page is the image or collection of images that is displayed to a user when a particular HTML file is rendered by a browser application program. Unless specifically stated, an electronic or web document may refer to either the source code for a particular web page or the web page itself. Each page can contain embedded references to images, audio, video or other web documents. The most common type of reference used to identify and locate resources on the Internet is the Uniform Resource Locator, or URL. In the context of the web, a user, using a web browser, browses for information by following references that are embedded in each of the documents. The HyperText Transfer Protocol (“HTTP”) is the protocol used to access a web document and the references that are based on HTTP are referred to as hyperlinks (formerly, “hypertext links”).

### Search Engines

Through the use of the web, individuals have access to millions of pages of information. However a significant drawback with using the web is that because there is so little organization to the web, at times it can be extremely difficult for users to locate the particular pages that contain the information that is of interest to them. To address this problem, a mechanism known as a “search engine” has been developed to index a large number of web pages and to provide an interface that can be used to search the indexed information by entering certain words or phrases to be queried. These search terms are often referred to as “keywords”.

Indexes used by search engines are conceptually similar to the normal indexes that are typically found at the end of a book, in that both kinds of indexes comprise an ordered list of information accompanied with the location of the information. An “index word set” of a document is the set of words that are mapped to the document, in an index. For example, an index word set of a web page is the set of words that are mapped to the web page, in an index. For documents that are not indexed, the index word set is empty.

Although there are many popular Internet search engines, they are generally constructed using the same three common parts. First, each search engine has at least one, but typically more, “web crawler” (also referred to as “crawler”, “spider”, “robot”) that “crawls” across the Internet in a methodical and automated manner to locate web documents around the world. Upon locating a document, the crawler stores the document's URL, and follows any hyperlinks associated with the document to locate other web documents. Second, each search engine contains information extraction and indexing mechanisms that extract and index certain information about the documents that were located by the crawler. In general, index information is generated based on the contents of the HTML file associated with the document. The indexing mechanism stores the index information in large databases that can typically hold an enormous amount of information. Third, each search engine provides a search tool that allows users, through a user interface, to search the databases in order to locate specific documents, and their location on the web (e.g., a URL), that contain information that is of interest to them.

The search engine interface allows users to specify their search criteria (e.g., keywords) and, after performing a search, an interface for displaying the search results. Typically, the search engine orders the search results prior to presenting the search results interface to the user. The order usually takes the form of a “ranking”, where the document with the highest ranking is the document considered most likely to satisfy the interest reflected in the search criteria specified by the user. Once the matching documents have been determined, and the display order of those documents has been determined, the search engine sends to the user that issued the search a “search results page” that presents information about the matching documents in the selected display order.

### Structure of Web Pages

The Internet today has an abundance of data presented in HTML pages. However, finding informative data from all the other content is still an arduous task. Many online merchants present their goods and services in a semi-structured format using scripts to generate a uniform look-and-feel template and present the information at strategic locations in the template. Identifying such positions on a page and extracting and indexing relevant information is key to the success of any data-centric application like search.

With the advent of e-commerce, most webpages are now dynamic in their content. Typical examples are products sold at discounted price that keep changing on sites between Thanksgiving and Christmas every year, or hotels that change their room fares on a seasonal basis. With advertisement and user services critical for business success, it is imperative that crawled content be updated on frequent and near real-time basis.

These examples show that on the Web, especially on large sites, webpages are generated dynamically through scripts that place the data elements from a database in appropriate positions using a defined template. By understanding these templates, one could separate out the more useful information on the pages from the text put in by the script as part of the template.

### Information Extraction Systems

Information Extraction (IE) systems are used to gather and manipulate the unstructured and semi-structured information on the web and populate backend databases with structured records. Most IE systems are either rule based (i.e., heuristic based) extraction systems or automated extraction systems. In a website with a reasonable number of pages, information (e.g., products, jobs, etc.) is typically stored in a backend database and is accessed by a set of scripts for presentation of the information to the user.

IE systems commonly use extraction templates to facilitate the extraction of desired information from a group of web pages. Generally, an extraction template is based on the general layout of the group of pages for which the corresponding extraction template is defined. One technique used for generating extraction templates is referred to as “template induction”, which automatically constructs templates (i.e., customized procedures for information extraction) from labeled examples of a page's content. To create labeled examples of a page's content, a person manually identifies and annotates the portions of the page that contain the desired information, which may be a time consuming process.

While an example has been provided of using templates to extract information from web pages, templates can be used to extract information from electronic documents having a structure other than an HTML structure. For example, templates can be used to extract information from documents structured in accordance with XML (eXtensible Markup Language).

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram that illustrates an Information Integration System (IIS), in which an embodiment of the invention may be implemented;

FIG. 2 depicts a diagram of automatically creating and generalizing a template, in accordance with an embodiment of the present invention;

FIG. 3 depicts a flowchart illustrating initial template creation, in accordance with an embodiment;

FIG. 4 depicts an example suffix tree created in accordance with an embodiment of the present invention;

FIG. 5 depicts an example regular expression (regex) tree created in accordance with an embodiment of the present invention;

FIG. 6A, FIG. 6B, and FIG. 6C depict examples of generalizing a template, in accordance with an embodiment;

FIG. 7 illustrates an initial template prior to matching with a DOM and a generalized template formed as a result of HOOK node processing, in accordance with an embodiment;

FIG. 8 illustrates an example template before it is compared to a DOM and the generalized template that results from generalizing the template as a result of OR node processing, in accordance with an embodiment of the present invention;

FIG. 9 is an overview of a process of generalizing a template, in accordance with an embodiment of the present invention;

FIG. 10 depicts an example of STAR addition to a template, in accordance with an embodiment;

FIG. 11A illustrates an example initial template, example DOM and a generalized template that is the result of adding a HOOK operator, in accordance with an embodiment;

FIG. 11B illustrates an example initial template, example DOM and a generalized template that is the result of adding a HOOK operator, in accordance with an embodiment;

FIG. 12 depicts an example of adding an OR node to generalize a template, in accordance with an embodiment;

FIG. 13 depicts generalizing a template across levels, in accordance with one embodiment;

FIG. 14 depicts generalizing a template across levels, in accordance with another embodiment;

FIG. 15A and FIG. 15B depict diagrams that illustrate matching and generalizing a template having a STAR operator, in accordance with an embodiment;

FIG. 16 depicts a flowchart of a process for learning characteristics of attributes, as well as a structural position of an attribute, in accordance with an embodiment of the present invention;

FIG. 17 illustrates a process of extracting attributes, in accordance with an embodiment;

FIG. 18 depicts a system for learning attribute characteristics, in accordance with an embodiment;

FIG. 19 depicts a system for candidate generation, in accordance with an embodiment;

FIG. 20 depicts a system for extracting attributes, in accordance with an embodiment;

FIG. 21 is a flow chart illustrating the steps of creating templates according to an embodiment of the invention; and

FIG. 22 is a block diagram that illustrates a computer system upon which an embodiment of the invention may be implemented.

### DETAILED DESCRIPTION OF EMBODIMENTS OF THE INVENTION

Techniques are described for automatically creating templates which may be used to extract information from documents, such as web pages coded in HTML. In the following description, for the purposes of explanation, numerous specific details are set forth in order to provide a thorough understanding of the embodiments of the invention presented herein. However, one skilled in the art will note that the embodiments of the invention presented herein may be practiced without these specific details. In other instances, well-known structures and devices are shown in block diagram form in order to avoid unnecessarily obscuring the embodiments of the invention presented herein.

Embodiments of the present invention are described in accordance with the following organization:
1) OVERVIEW OF INDUCING TEMPLATES
2) OVERVIEW OF AUTOMATIC CREATION OF TEMPLATES
3) SYSTEM ARCHITECTURE EXAMPLE
4) OVERVIEW OF INDUCING TEMPLATES IN ACCORDANCE WITH AN EMBODIMENT
5) TEMPLATE CREATION
   a) INITIAL TEMPLATE CREATION
   b) GENERALIZING THE TEMPLATE
      i) IDENTIFICATION OF APPROXIMATION LOCATIONS AND BOUNDARY
6) GENERALIZING THE TEMPLATE BASED ON A TRAINING SET OF DOCUMENTS
   a) COMPARING TEMPLATE TO TRAINING SET
      i) STAR NODE PROCESSING
      ii) HOOK NODE PROCESSING
      iii) OR NODE PROCESSING
   b) GENERALIZING THE TEMPLATE BASED ON COMPARISON WITH TRAINING SET
      i) STAR ADDITION
      ii) HOOK ADDITION
      iii) OR ADDITION
      iv) ADDITION OF OPERATORS ACROSS TREE LEVELS
      v) COST OF GENERALIZING THE TEMPLATE
6) OVERVIEW OF EXTRACTING INFORMATION BASED ON DOCUMENT STRUCTURE AND CHARACTERISTICS OF ATTRIBUTES
7) PROCESS FOR LEARNING CHARACTERISTICS OF ATTRIBUTES AND STRUCTURAL POSITION OF ATTRIBUTES
8) PROCESS FOR EXTRACTING ATTRIBUTES BASED ON LEARNED ATTRIBUTE CHARACTERISTICS AND STRUCTURAL POSITION OF ATTRIBUTES
9) SYSTEM FOR LEARNING ATTRIBUTE CHARACTERISTICS
10) CANDIDATE GENERATION FOR A PARTICULAR ATTRIBUTE
11) SYSTEM FOR EXTRACTING ATTRIBUTES
12) EXAMPLE FILTERS
   A) Property Based Filter
   B) Position Based Filter
   C) Range Pruner
   D) Contextual Filter
   E) Regex Filter
   F) Tag-specific Filter
   G) Text Manipulation Filter
13) AUTOMATED CREATION OF TEMPLATES
A) INITIAL CREATION OF AT LEAST ONE SEED TEMPLATE AND IDENTIFICATION OF CLUSTERS
   B) EXTRACTING ATTRIBUTES
   C) IDENTIFYING MATCHING DOCUMENTS
      i) INDEXING
      ii) FUZZY SIMILARITY METRICS
      iii) FINGERPRINTING
      iv) TRIE BASED LOOKUP
   D) GROUPING MATCHING DOCUMENTS BY CLUSTER ID
   E) ANNOTATING MATCHING DOCUMENTS USING A SEED TEMPLATE
   F) IDENTIFYING FOR WHICH CLUSTERS A NEW TEMPLATE SHOULD BE GENERATED
   G) GENERATING A NEW TEMPLATE
   H) AUTOMATED ITERATION OF TEMPLATE CREATION
14) HARDWARE OVERVIEW

### Overview of Inducing Templates

Techniques are disclosed herein to automatically learn a template that describes a common structure present in documents in a training set. In one embodiment, the training documents are selected from a cluster of structurally similar documents. The cluster can be generated by applying a clustering algorithm to a large set of documents. The documents could be HTML documents (e.g., web pages), XML documents, documents in compliance with other markup languages, or some other structured document.

In one embodiment, the template is expressed as a tree. The structure of the template is compared to the structure of the documents (or at least a part of each document) in the training set, one-by-one, and generalized in response to differences between the template and the document to which the template is currently being compared. Generalizing the template to match a particular document results in a more general template structure that will match the structure of the particular document, while preserving the template's match to documents to which the template was previously matched. Thus, the generalized template describes a common structure present in the documents in the training set.

In one embodiment, a document object model (DOM) tree is constructed for at least a portion of a document to facilitate comparison with the template. Generalizing the template is achieved by generalizing the structure of the template such that the template's more general structure will match the structure of the DOM for the document, in one embodiment. Various example “generalization operators” are described herein, which may be added to the template to generalize the template. If the structure of any particular document is considered to be too dissimilar from the structure of the template, then the template is not generalized to match the particular document.

After the template is created, the template can be used to extract information from documents outside of the training set. As an example, the template could be learned from a training set of web pages associated with a shopping web site. The learned template could be used to extract information such as product descriptions, product prices, product reviews, product images, etc. Some portions of the documents, such as banner ads, may not be of interest. Thus, the template might only describe the common structure of a portion of the shopping web pages, such as the portion that pertains to the product or products for sale. Because the template can be learned in an automated fashion, templates can be learned across applications to all kinds of script generated websites. Prior to using the template for extraction, there may be some additional modifications. For example, the template could be annotated with attributes that are of interest, wherein those attributes can be extracted from documents that were not used to construct the template.

### Overview of Automatic Creation of Templates

A template identifies content that is desired to be extracted from a document. Content which may be extracted from a document using a template includes any type of data which may form part of a document, such as text, images, videos, and hyperlinks.

As shall be discussed in further detail below in the section entitled “TEMPLATE CREATION,” the process of creating an initial template involves the use of annotated training documents. Previously, annotation of a training document was typically performed manually, and involved identifying the portions of the training document which contain the desired information to be extracted. As a result of the amount of time and effort involved in manually annotating training documents, the creation of templates using manually annotated training documents does not scale to accommodate the creation of a large number of templates.

Embodiments of the invention overcome these limitations using an approach to achieve automated creation of templates based on the Intension-Extension of the relation between templates and extracted attributes. Using embodiments of the invention, a small seed set of templates may be used to iteratively create additional templates which, in the aggregate, have the ability to extract attributes from billions of web pages without manual intervention.

Embodiments of the invention which operate on web pages exploit two patterns. The first pattern is the duplicity of the structure of a web page in a particular web site. A large amount of content that is desired to be extracted (for example, shopping data, news data, etc.) resides within a database. Web sites often use automated processes to retrieve data from databases, populate web page templates with the retrieved data, and display the web pages to the users. Therefore, a large number of web pages within a particular web site tend to be structurally similar and differ only by the content displayed on the web page. Thus, by learning an extraction template for one web page of a web site, the same extraction template may be used on another web page of the web site that is structurally similar.

The second pattern recognized and exploited by embodiments of the invention is the duplicity of content across web sites. Two different shopping web sites are very likely to carry information about the same product. The product information for a product may be considered to be a record. Thus, a record displayed on a first web page of a first web site may be found on a second web page on a second web site by matching attributes of a record extracted from the first web site with the content of the second web page of the second web site.

The following discussion illustrates how an embodiment may operate. Initially, a collection of documents (such as a large number of web pages on the World Wide Web) are arranged into clusters of documents. Contemporaneously, a user manually annotates a small number of training documents for one or more clusters. A template (referred to as a “seed template”) for each cluster is created using the small number of manually annotated training documents. The seed template is used to extract attributes of records (collectively referred to as “the seed records”) from documents in a cluster. For example, the seed records may include information about a particular product being offered for sale on a web site. The information may include the product's name, price, and description, for example.

Thereafter, other documents that contain attributes similar to those of the seed records are identified. For example, if the seed records are extracted from a web page of a web site associated with company ABC (“the ABC web site”), then another web page of a web site associated with company XYZ (“the XYZ web page”) may be identified if the XYZ web page contains attributes similar to the seed records, as would be expected if both the ABC company and the XYZ company sell the same product on their websites. Once other documents (denoted “matching documents”) that contain attributes similar to the seed records are identified, those documents may be grouped according to which cluster they belong.

Subsequently, at least a portion of the matching documents may be annotated using the seed records extracted using the seed template. Advantageously, the annotation of documents is performed using an automated process that does not require human intervention. Thereafter, a new template may be created for each of the clusters of documents that contained an annotated document. The new template created for a cluster may subsequently become a new seed template for the cluster, and the process may be repeated. In this way, the process may be repeated over many iterations until a determination is made that additional templates should not be created. For example, new seed templates for a particular cluster might not be created if the creation would introduce an unacceptable amount of noise.

Advantageously, creating templates in this manner scales to accommodate the creation of a large number of templates. Further, the templates created in this manner yield high precision results due to, at least in part, the noise filtering considerations. Additional details regarding the automated creation of templates are discussed in the section entitled “Automated Creation of Templates.”

### System Architecture Example

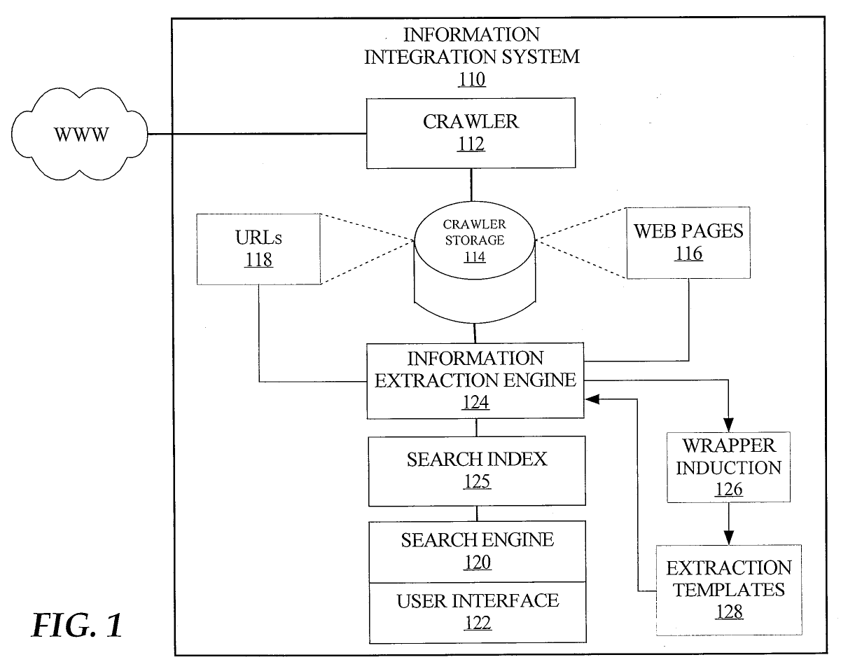

FIG. 1 is a block diagram that illustrates an Information Integration System (IIS), in which an embodiment of the invention may be implemented. The context in which an IIS can be implemented may vary. For non-limiting examples, an IIS such as IIS 110 may be implemented for public or private search engines, job portals, shopping search sites, travel search sites, RSS (Really Simple Syndication) based applications and sites, and the like. Embodiments of the invention are described herein primarily in the context of a World Wide Web (WWW) search system, for purposes of an example. However, the context in which embodiments are implemented is not limited to Web search systems. For example, embodiments may be implemented in the context of private enterprise networks (e.g., intranets), as well as the public network of networks (i.e., the Internet).

IIS 110 can be implemented comprising a crawler 112 communicatively coupled to a source of information, such as the Internet and the World Wide Web (WWW). IIS 110 further comprises crawler storage 114, a search engine 120 backed by a search index 125 and associated with a user interface 122.

A web crawler (also referred to as “crawler”, “spider”, “robot”), such as crawler 112, “crawls” across the Internet in a methodical and automated manner to locate web pages around the world. Upon locating a page, the crawler stores the page's URL in URLs 118, and follows any hyperlinks associated with the page to locate other web pages. The crawler also typically stores entire web pages 116 (e.g., HTML and/or XML code) and URLs 118 in crawler storage 114. Use of this information, according to embodiments of the invention, is described in greater detail herein.

Search engine 120 generally refers to a mechanism used to index and search a large number of web pages, and is used in conjunction with a user interface 122 that can be used to search search index 125 by entering certain words or phrases to be queried. In general, the index information stored in search index 125 is generated based on extracted contents of the HTML file associated with a respective page, for example, as extracted using extraction templates 128 generated by template induction processes 126. Generation of the index information is one general focus of the IIS 110, and such information is generated with the assistance of an information extraction engine 124. For example, if the crawler is storing all the pages that have job descriptions, an extraction engine 124 may extract useful information from these pages, such as the job title, location of job, experience required, etc., and use this information to index the page in the search index 125. One or more search indexes 125 associated with search engine 120 comprise a list of information accompanied with the location of the information, i.e., the network address of, and/or a link to, the page that contains the information.

As mentioned, extraction templates 128 are used to facilitate the extraction of desired information from a group of web pages, such as by information extraction engine 124 of IIS 110. Further, extraction templates 128 may be based on the general layout of the group of pages for which a corresponding extraction template 128 is defined. For example, an extraction template 128 may be implemented as an HTML file that describes different portions of a group of pages, such as the fact that a product image is to the left of the page, the fact that a price of the product is in bold text, the fact that the product ID is underneath the product image, etc. Template induction processes 126 may be used to generate extraction templates 128. Interactions between other components of embodiments of the invention and template induction processes 126 and extraction templates 128 are described in greater detail herein.

### Overview of Inducing a Template in Accordance With an Embodiment

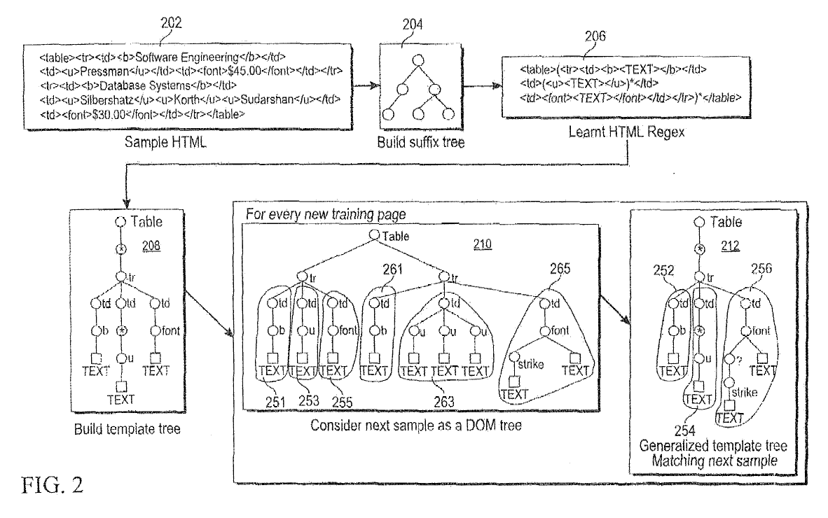

The diagram in FIG. 2 illustrates an overview of automatically creating and generalizing a template, in accordance with an embodiment of the present invention. In general, first an initial template is created. Then, the initial template is generalized by comparing the template to a set of training documents. In particular, the template is compared to a DOM for at least a portion of each of the training documents. Thus, herein the phrase “comparing the template to a DOM”, and other similar phrases, refers to comparing the structure of the template to the structure of a DOM that models at least a portion of a document. The initial template is created based on sample HTML 202, in an embodiment. For example, if the goal is to build a template that is suitable for shopping web sites, then a relevant portion of a shopping page could be input.

In this embodiment, a suffix tree 204 is created from the sample HTML 202. A suffix tree 204 is a data-structure that represents suffixes starting from all positions in the sequence, “S.” The suffix-tree 204 can be used to identify continuous-repeating patterns. However, a structure other than a suffix tree 204 can be used to identify patterns. The suffix tree 204 is analyzed to generate a regular expression (“Regex”) HTML 206. Further details of creating a suffix tree 204 and a regex are discussed below under the heading “initial template creation.”

An initial template 208 is generated from the regex 206. In one embodiment, a template includes HTML nodes and nodes corresponding to defined operators. An example of an HTML node is an HTML tag (e.g., title, table, tr, td, h1, h2, p, etc.). Examples of defined operators include, but are not limited to, STAR, HOOK, and OR. A STAR operator indicates that any subtrees that stem from children of the STAR operator are allowed to occur one or more times in the DOM. A HOOK operator indicates that the underlying subtrees are optional. In one embodiment, a HOOK operator is allowed to have only one underlying subtree. In other words, a HOOK operator is allowed to have only a single child, in one embodiment. An OR operator in the template indicates that only one of the sub-trees underlying the OR operator is allowed to occur at the corresponding position in the DOM. It is not required that the template contain HTML nodes. In one embodiment, the template includes XML nodes and nodes corresponding to defined operators.

Box 210 depicts an example DOM structure for a document in the training set. Box 212 depicts a generalized version of the template 212, which is automatically generated in accordance with an embodiment. As previously mentioned, the template is generalized such that the template's structure matches that of a common structure of the training documents. To generalize the template 212 to match a particular DOM structure 210, first the template 212 is compared to the DOM 210 to determine what the differences are. Differences are resolved by adding one or more operators to the template 212, which results in matching the template 212 to the current DOM 210 by making the template 212 more general. The changes to the template 212 are made in such a way that the template 212 will still match with DOMs 210 for which the template 212 was previously generalized to match.

### Template Creation

### A) Initial Template Creation

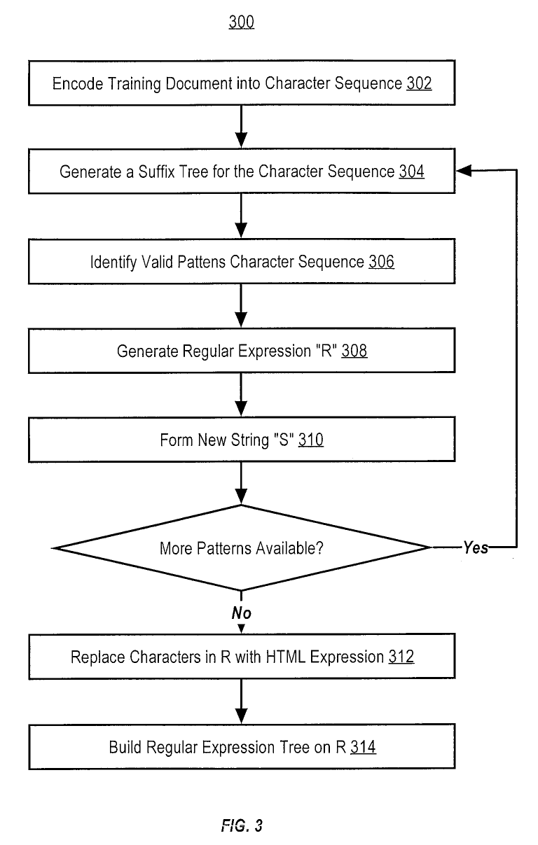

The following section describes initial creation of a template, in accordance with one embodiment. FIG. 3 depicts a flowchart illustrating a process 300 of initial template creation, in accordance with an embodiment. In step 302, a training document (e.g., HTML page) is encoded into a character sequence, S=s₁, s₂ . . . sₙ. In an embodiment, all text outside of HTML tags is encapsulated into a special <TEXT> token. For example, the text that describes an item for sale on a shopping site web page would be represented as a TEXT token. The HTML tags themselves are also represented as tokens. For example, there could be a TABLE token, a TABLE ROW token, etc. Then, each token is mapped to a character si (or a unique group of characters s₁ . . . sₖ, if required).

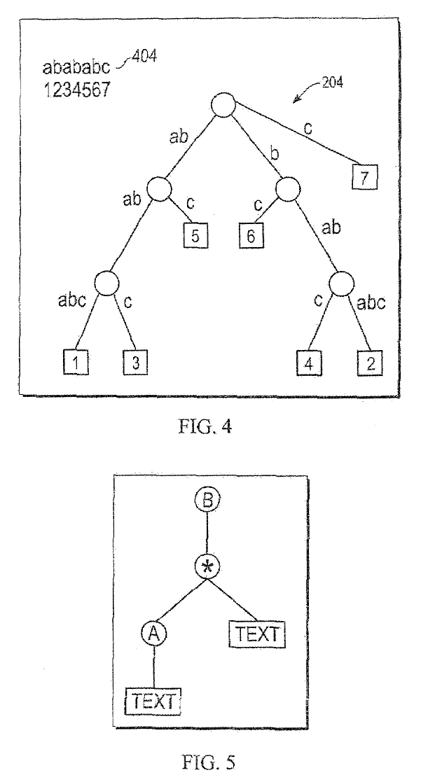

In step 304, a suffix-tree is built on the character sequence “S.” FIG. 4 depicts an example suffix tree 204, in accordance with an embodiment. The example suffix tree 204 reflects patterns in the character sequence 404. The patterns may be identified by analyzing sub-strings within the character sequence 404. As an example of continuous-repeating patterns, in FIG. 4 “ab” (starting at position 1 and position 3) in the character sequence 404 and “ba” (starting at position 2 and position 4) are identified as repeating patterns. The pattern “abc” starting at position 5 is an example of a pattern that is not repeated.

In step 306, valid patterns are identified. For example, certain tags should have an “open” tag followed, at some point, by a “close” tag. As a particular example, a “bold open tag” should precede a “bold close tag”. This required sequence of tags can be used to identify patterns that are valid and invalid.

In step 308, a regular expression, “R”, is constructed. Step 308 includes several sub-steps including replacing multiple occurrences in the suffix tree with a single occurrence. As an example, the suffix tree has multiple occurrences of “ab”, which are replaced by a single occurrence “ab*”, where the “*” indicates that pattern occurs more than once in the suffix tree. For example, from the character sequence S, a regular expression R is constructed by replacing multiple occurrences of a pattern in S by an equivalent regular expression. In the example from FIG. 4, “ababab” in S is replaced by “(ab)*”. Thus, from S=“abababc”, the expression R=“(ab)*c” may be generated. The suffix tree is used to find these multiple occurrences, but does not store the regular expression.

In step 310, another string, S′, is formed. The new string S′ is formed by neglecting all of the patterns in R having a “*” character, in an embodiment.

Steps 304-310 are repeated on S′ to find more complex and nested patterns. Steps 304-310 may be repeated until no more patterns are available. At the end of this phase, a regular expression, R, is available with multiple occurrences replaced by a starred-single occurrence.

In step 312, all characters in R are replaced by their equivalent HTML tag from step 302.

In step 314, a regular-expression tree is built on R, such that any nested HTML tag is represented as a hierarchy. FIG. 5 shows an portion of an example regular-expression tree for the following expression:

<B>(<A><TEXT></A><TEXT>)*</B>

A full regular expression tree serves as the basis for an initial template to be used to compare with documents in a training set, in one embodiment. However, as is discussed in the next section, the initial template can be generalized prior to comparing the template to training documents.

### B) Generalizing the Initial Template

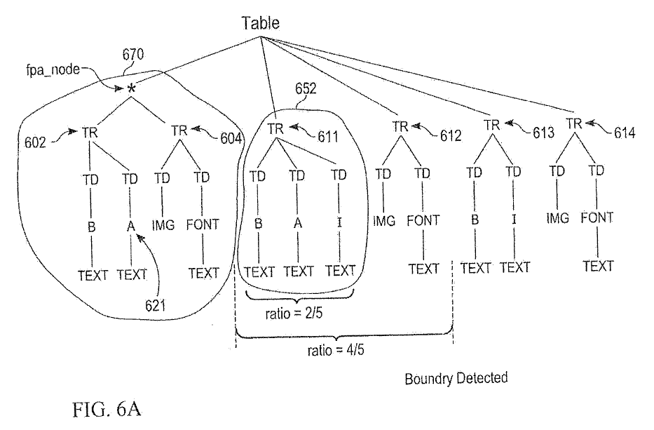

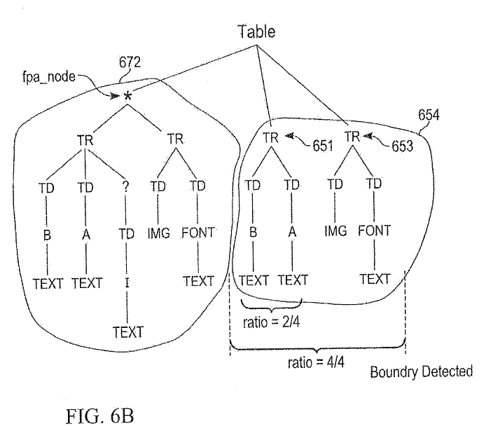

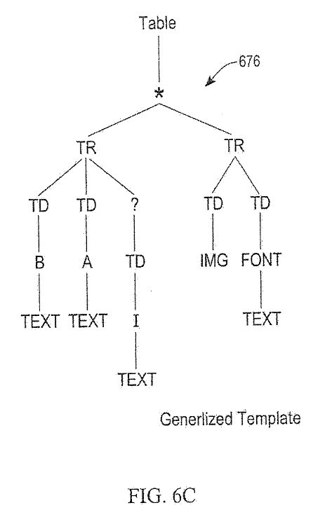

After initial creation, the template may have sub-trees that are approximately, although not exactly, the same. As an example, FIG. 6A shows a node “fpa_nde” that has a sub-tree formed from the nodes 602, 604 and their children. There are also sub-trees formed from each of nodes 611, 612, 613, 614, and their respective children. There is some similarity in the sub-trees. As the previous section describes, sub-trees that are identical are merged. The “STAR” operator is used to indicate that more than one sub-tree is represented. The following generalization process is used to merge sub-trees that are substantially similar, but not identical.

In one embodiment, similar sub-trees in the template are merged and generalized using a similarity function on the paths of the template. In an embodiment, this generalization process involves two phases: i) identification of approximation locations and boundary; and ii) approximation methodology.

### i) Identification of Approximation Locations and Boundary

Initially, a set of candidate nodes in the template are identified for a determination as to whether a sub-tree of a particular candidate node has similar sub-trees. For example, all STAR nodes are considered candidate nodes. The sub-tree associated with a particular STAR node may be compared with the sibling sub-trees of the same STAR nodes to look for similar sub-trees. The candidate nodes do not have to be STAR nodes, but could be any set of nodes. Typically, the candidate nodes will be the same type of nodes. In the following discussion, the template node whose sub-tree is under consideration for similar sub-trees is referred to as “fpa_node.”

A modified similarity function is used to find the boundary of match, in an embodiment. Initially, all “paths” within the selected template node, fpa_node, are determined. A path from an arbitrary node “p” is defined as a series of HTML tags starting from node p to one of the leaf nodes under node p.

The following example with respect to FIG. 6A, FIG. 6B, and FIG. 6C will be used to illustrate. First, all “paths” within the selected template node fpa_node are determined. These will be referred to as “fpa_node paths”. A path from a node p is defined as a series of HTML tags starting from p to one of the leaf nodes under p, in an embodiment. Hence, the fpa_node paths in FIG. 6A are: tr/td/B/TEXT, tr/td/A/TEXT, tr/td/IMG, and tr/td/FONT/TEXT.

Next, paths are computed for the siblings of fpa_node. These will be referred to as “sibling paths”. For example, sibling 611 has three sibling paths. The computed sibling paths are compared to the fpa_node paths to look for path matches. A path match occurs when a fpa_node path matches a sibling path, in an embodiment. In the following discussion, the “current sibling”refers to the sibling whose paths are currently being compared to the fpa_node paths. Based on the number of matching paths, a similarity score is computed, in an embodiment. The numerator is the number of fpa_node paths that have a match in the sibling paths. The denominator is the number of unique fpa_node paths and all sibling paths up until the current sibling. For example, referring to FIG. 6A, the ratio of matching paths from fpa_node paths to sibling nodes 611 and 612 is 2/5 and 4/5, respectively. Herein, the ratio will be referred to as a “similarity score”.

If the current similarity score is at least a specified threshold, then that sibling node is considered to be a “boundary”. As an example, if the threshold were 1/3, then sibling node 611 would be considered to be a boundary.

However, if the current similarity score is not greater than the specified threshold, then the paths from the next sibling node are combined and a similarity score is computed. Referring to FIG. 6A, the paths of siblings 611 and 612 are combined. The similarity score of the sibling paths and the fpa_node paths is 4/5. In one embodiment, if the similarity score is greater than the specified threshold, then the siblings are considered to be candidates for merging (in other words, a boundary has been found). If in FIG. 6A, the similarity score (4/5) up to template node 612 is greater than the specified threshold (e.g., 3/4), then template node 612 is called a “boundary” node. In one embodiment, the range of the siblings up until the boundary node is considered for merging.

If there is a HOOK node present in a path under the fpa_node, then the HOOK node is only considered if there is a path under a sibling set that matches this “optional path”, in an embodiment.

Paths containing OR are weighed against each other such that the presence of any one of the paths is treated as a presence of the entire set, in an embodiment. For example, if there are three children to an OR node, then there will be at least three paths through this OR node—one through each of these three children. There may be more than three paths if these children have a sub-tree below them; however, to facilitate explanation, this example assumes there are only three paths. Because an OR node mandates that only one of each of the three paths is allowed, then if any one of this set of three paths is present in the sibling's paths, then the entire set is treated as present, in an embodiment. Thus, a count of one is added to the numerator and denominator of the ratio fraction, if at least one of the paths under the OR node matches. Otherwise, a count of one is added only to the denominator.

Once merging happens successfully, the process is repeated for remaining sibling sub-trees. The merging is determined to be successful if the cost of modifying the template is less than a cost threshold; otherwise merging is determined to have failed. For example, the sub-trees associated with siblings 611 and 612 from FIG. 6A are merged with the sub-tree under the fpa_node shown in FIG. 6B. The merging is performed by generalizing the sub-tree under the fpa_node such that the sub-tree under the fpa_node matches with the sub-trees associated with siblings 611 and 612. Details of generalizing a template are described below. After the merging, the sub-trees under siblings 651 and 653 are considered for merging with the sub-tree under the fpa_node, as shown in FIG. 6B.

Once the boundary is identified, the template is generalized based on the segments. In an embodiment, generalizing the template based on the segments is performed using techniques discussed herein under the heading “GENERALIZING THE TEMPLATE BASED ON A TRAINING SET OF DOCUMENTS.” That section describes how a template can be generalized to match a single training document or partial document sub-tree. In the present example of generalizing the initial template, a portion of the template, referred to herein as a template component 670, is matched to other portions of the template, referred to herein as template segments or sub-trees. That is, template sub-trees corresponding to segments in the template are matched with the template component 670 to generalize the template component 670. In particular, first the template component 670 is generalized to match the first template segment 652, as shown in FIG. 6A, which results in the modified template component 672 as shown in FIG. 6B. Then, the modified template component 672 is generalized to match the second template segment 654, as shown in FIG. 6B, which results in the generalized template component 676, as shown in FIG. 6C. As discussed herein, generalizing the template component (or portion thereof) to match a template segment means that a comparison of the generalized template component with the template segment will not have any mismatches when applying a set of rules that determine whether the generalized template component matches the template segment.

### Generalizing the Template Based on a Training Set of Documents

### A) Comparing Template to Training Set

The template includes either HTML nodes or nodes corresponding to one of the defined operators (e.g., STAR, HOOK, OR), in an embodiment. FIG. 2 depicts template 212, which contains an example of a HOOK operator that has been added to a template, in accordance with an embodiment. The STAR operator is represented by ‘*’, and the HOOK operator is represented by ‘?’.

When a new document is given for learning, the DOM of the document is matched with the template in a depth first fashion, in an embodiment. Depth first matching means that processing proceeds from a parent node to the leftmost child node of the parent. After processing all of the leftmost child's subtrees in a depthmost fashion, the child to the right of the leftmost child is processed. When there is a mismatch between tags, a mismatch routine is invoked in order to determine whether to match the template to the DOM.

Comparing the template to the DOM depends on the type of operator that is the parent of a sub-tree in the template, in an embodiment. For example, if a STAR operator is encountered in the template, then the sub-tree of the STAR operator is compared to the corresponding portion of the DOM in accordance with STAR operator processing, as described below. Sub-trees having a HOOK operator or an OR operator as a parent node are processed in accordance with HOOK operator processing and OR operator processing respectively, in accordance with an embodiment.

### Star Node Processing

Processing of a sub-tree under a STAR node in the template occurs by traversing the nodes in the sub-tree in a depthmost fashion, comparing the template nodes with the DOM nodes. If all children match at least once, then the STAR sub-tree matches the corresponding sub-tree in the DOM. As an example, referring to FIG. 2, the leftmost “tr” node in the DOM 210 matches the STAR subtree in the template as follows. Sub-tree 251 matches sub-tree 252. Then sub-tree 253 is compared to sub-tree 254, wherein these paths are determined to match. Sub-tree 254 itself contains a STAR node, which could result in the recursive re-invocation of the routine that processes STAR subtrees. Furthermore, since sub-tree 254 has at least one instance of u/text, sub-tree 254 matches with sub-tree 253. Sub-tree 255 matches sub-tree 256 because each sub-tree has td/font/text. A routine could be invoked to evaluate the HOOK path in the subtree. Because the HOOK operator indicates that the subtree below the HOOK is optional, the DOM is not required to have that subtree in order to match.

After processing the leftmost subtree in the DOM 210, the rightmost subtree is compared to the template subtree 212 (because template contains a STAR node). Sub-tree 261 matches sub-tree 252. Sub-tree 263 contains three instances of td/u/text. Because of the STAR operator in sub-tree 254, the sub-trees match. That is, the DOM 210 is allowed to have one or more sub-trees td/u/text and still will be considered a match. Sub-tree 265 matches sub-tree 256. Notably, sub-tree 256 has the optional path td/font/strike/text path.

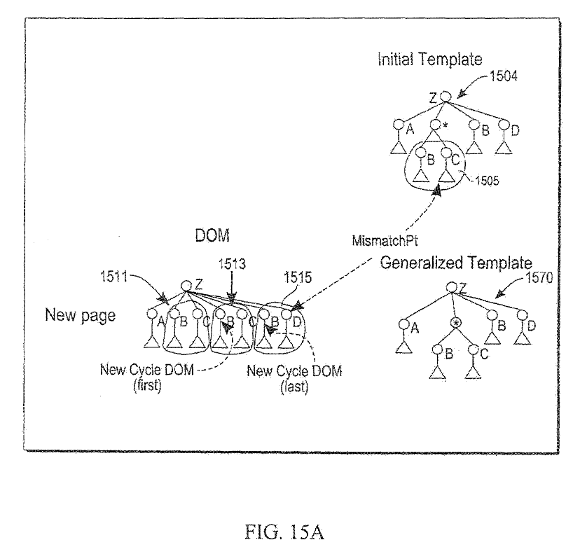

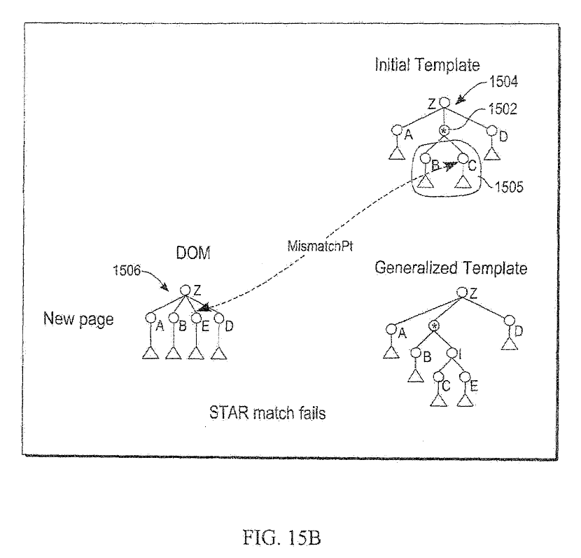

FIG. 15A and FIG. 15B will be used to illustrate how mismatches between the template STAR sub-tree and the DOM may be handled, in accordance with an embodiment. As previously discussed, the subtree under a STAR node may be present in the DOM more than one time. Processing depends on whether all of the children of the STAR node have matched the DOM at least once. FIG. 15A depicts an example in which all of the children of the STAR have matched the DOM at least once. For example, DOM sub-trees 1511 and 1513 match with the STAR sub-tree 1505. FIG. 15B depicts an example in which the sub-tree 1505 of the STAR node 1502 does not match the DOM 1506 at all. For example, the A node in the DOM 1506 matches the A node in the template 1504. However, the B node and E node in the DOM 1506 do not match with the B node and the C node in the template 1504. Therefore, there is a mismatch point (“mismatchPt” in FIG. 15B) between the E node of the DOM 1506 and the C node of the template 1504. Moreover, the DOM 1506 does not have even one occurrence of the STAR sub-tree 1505 at the correct location.

When processing the STAR sub-tree 1505, if there is a mismatch between the STAR sub-tree 1505 and the sub-tree in the DOM under consideration for this cycle, a determination is made as to whether the STAR sub-tree 1505 has matched in the DOM at least once. If the STAR sub-tree 1505 has not matched even once, then the STAR sub-tree 1505 is said to have failed the match, and a mismatch routine is called. The mismatch routine is informed that the STAR sub-tree 1505 failed to match at all, in an embodiment. The mismatch routine is provided with the identity of the nodes which mismatched, in an embodiment. For example, referring to FIG. 15B, the E node in the DOM 1506 and the C node in the template 1504 are identified.

FIG. 15A will be used to illustrate how processing may be performed if the STAR sub-tree 1505 has matched in the DOM at least once. Notably, processing the STAR sub-tree may include performing a number of cycles. For example, in FIG. 15A, the STAR sub-tree 1505 is compared to three different sub-trees 1511, 1513, and 1515 in the DOM. During the first cycle, DOM sub-tree 1511 is determined to match with the STAR sub-tree 1505; therefore, matching starts again at the position indicated in FIG. 15A by newCycleDOM(first). During the second cycle, DOM sub-tree 1513 is determined to match with the STAR sub-tree 1505; therefore, matching starts again at the position indicated in FIG. 15A by newCycleDOM(last). During the third cycle, DOM sub-tree 1515 is determined to not match with the STAR sub-tree 1505. However, because the STAR sub-tree 1505 matched at least once, the STAR sub-tree match is successful. Processing then proceeds from the B node in newCycleDOM(last) of the DOM and the next node in the template 1504 (which is the B node). Notably, the B node in the DOM did have a match in the template sub-tree 1505. However, processing begins at B node because the entire STAR sub-tree 1505 was not matched for that cycle. Thus, the matching routine is restarted with the DOM node that was used for matching the first child (leftmost child) in the sub-tree 1505 under the STAR node 1502. Since the template 1504 matches completely with the DOM, template 1504 remains unchanged after matching.

In the current examples, the STAR node 1502 had a sibling to the right of STAR node 1502. That is, the STAR node 1502 and the D node are both children of the Z node, in FIG. 15B. If a STAR node has no right sibling nodes, then the matching may proceed with the next node in the template 1504 at the same logical level in the template 1504 as the STAR node 1502. When a logical level in a template is determined, the presence of an operator node is not considered as a logical level. In a template, two nodes n₁ and n₂ are considered to be in the same logical level if those nodes have a common non-operator ancestor N, and all nodes between N and n₁, and N and n₂ are operator nodes. If no node is found to the right of the STAR node 1502, then the mismatch routine may be called on the current template and DOM nodes. The current template and DOM nodes mean the nodes at which the mismatch point (mismatch Pt) occurred.

### Hook Node Processing

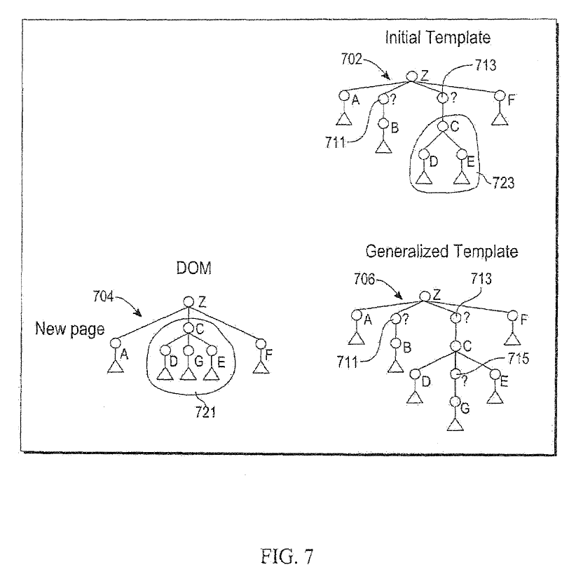

If the template node is a HOOK, then the DOM node is matched with children of the HOOK node. FIG. 7 illustrates an initial template 702 prior to matching with a DOM 704 and generalized template 706 as a result of the comparison, in accordance with an embodiment. In FIG. 7, nodes having an A, B, . . . , Z denote distinct HTML tags, while triangles represent subtrees of the node above the subtree. In this example, a HOOK node has only a single child (although multiple grandchildren). A HOOK node is only allowed to have a single child, in one embodiment. However, in another embodiment, a HOOK node may have multiple children. If the subtree in the DOM matches the sub-tree under the HOOK node in the template, then the matching continues with the next template and DOM nodes. For example, HOOK node 711 “matches” with the DOM 704 because the DOM 704 is not required to have the B node below the HOOK node 711. Therefore, the matching continues with HOOK node 713.

If the sub-tree under a HOOK node matches only partially with the sub-tree under the corresponding DOM node, then the extent of match is recorded. The extent of the match may be based on the number of nodes in the sub-tree that do match and the number that do not match. For example, for the sub-tree of HOOK node 713, nodes C, D, and E match with the DOM sub-tree 721. However, since node G from the DOM sub-tree 721 is not found in the sub-tree of HOOK node 713 it is a mismatch. The extent of the mismatch can be expressed as a ratio, percentage, etc., that reflects that fact that three nodes match and one node does not match. Different nodes can have different weights when computing the extent of match. For example, nodes can be weighted based on those nodes' levels in the tree. In one embodiment, nodes at a higher logical level in the tree are assigned a greater weight.

When a sub-tree in the DOM 704 fails to match a sub-tree in the template 702, then the sub-tree in DOM 704 is matched with sub-trees that are rooted at template nodes that are siblings of the template node that was the root of the mismatch. This continues on until the root template node is not a HOOK node. For example, in template 702, the template node that is a mismatch is HOOK node 713. The next node is the F node, as processing is from left to right in this embodiment. Because the F node is not a HOOK node, this is the last node that is compared to the mismatched sub-tree 721 in the DOM 704. If there were more HOOK nodes between HOOK node 713 and node F, then the subtrees of each of the HOOK nodes would be compared with the mismatched sub-tree 721. If any of these hypothetical template subtrees are an exact match with the mismatched sub-tree 721, then the mismatched sub-tree 721 would be considered to have matched with the template 702. However, if none of these hypothetical template sub-trees match the mismatched sub-tree 721, then one of the template sub-trees is selected to be modified such that the template sub-tree will match the mismatched sub-tree 721. In one embodiment, the template subtree that comes closest to matching the mismatched sub-tree 721 is selected for modification.

Referring to FIG. 7, the C subtree 723 in the template 702 comes closest to matching the mismatched subtree 721 in the DOM 704. In this case, the C sub-tree 723 in the template 702 is modified to match the C sub-tree in the DOM. In particular, the HOOK node 715 and G node are added to the C-subtree 723 in the generalized template 706. However, a new sub-tree might possibly be added in the template 702 instead of modifying an existing sub-tree. For example, because the mismatched subtree 721 occurs between the A and F nodes in the DOM 704, a new subtree might be added to the template somewhere between the A node and F node. This might be done if the template does not have an existing sub-tree that is a close enough match to the mismatched sub-tree 721 in the DOM 704. In one embodiment, a cost of modifying the template 702 is computed to determine how to modify the template. Determining how to modify the template can include determining a location, types of nodes, etc. A decision can also be made regarding whether or not to modify the template, based on a cost.

### OR Node Processing

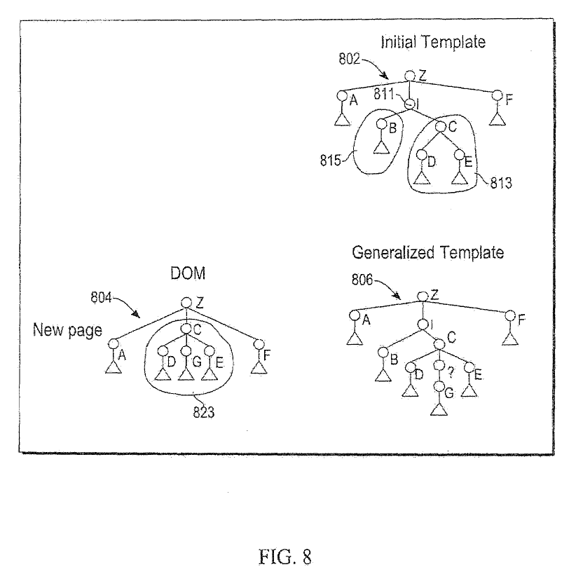

FIG. 8 illustrates an example initial template 802 that is compared to a DOM 804, and the generalized template 806 that results from generalizing the initial template 802 to match the DOM 804, in accordance with an embodiment of the present invention. The template has an OR node 811 and two OR sub-trees 813, 815. In this example, the template OR node 811 has multiple children. The C sub-tree 823 in the DOM 804 is matched with each sub-tree 813, 815 of the OR node 811. An extent of match is recorded for each comparison. For example, the DOM C sub-tree 823 does not match well with the sub-tree 815, but comes close to matching the sub-tree 813. If the DOM C sub-tree 823 had an exact match in the template 802, then there would be no need for a modification. In this case, the closest match in the template 802 is the sub-tree 813, which is missing a G node relative to the DOM subtree 823. A decision is made to modify sub-tree 813 such that sub-tree 813 matches the DOM C sub-tree 823. A new sub-tree also might possibly be added to the template 802 to match the DOM C sub-tree 823. Adding a sub-tree to the template is performed if the cost of modifying an existing sub-tree in the template is less than a specified threshold, in one embodiment.

When comparing a template node to DOM node, if the names (e.g., tag names) do not match, then a mismatch routine is called with an indication of the mismatched template node and DOM nodes. In template 802, there might be a node that has no corresponding node in the DOM 804 or vice versa. For example, the G node in the DOM 804 has no corresponding node in the template 802. For this type of mismatch, a mismatch routine is called with an additional indication that one of the two nodes (in DOM and Template) is absent. Notably, when processing an OR sub-tree, there is no requirement that an OR operator be added. For example, in FIG. 8, a HOOK operator is added to the OR subtree 813 to resolve the mismatch between the template 802 and the DOM.

### B) Generalizing the Template Based on Comparison With Training Set

When a mismatch routine is called due to a mismatch between the template and the DOM, a determination is made as to whether to resolve the mismatch by generalizing the template. If the template is generalized, then the mismatch is ensured to be resolved by adding an appropriate STAR, HOOK, or OR operator, thereby generalizing the template, in an embodiment. In an embodiment, when the mismatch routine is called, a template node “w” and a DOM node “d” are provided to the mismatch routine to indicate where a mismatch occurred. A mismatch can occur in two cases: (i) when the structure of the template and DOM have corresponding nodes, but the nodes not match with each other, and (ii) when the structure is such that a node is absent in either the template or the DOM. If there are corresponding nodes that do not match, then “w” and “d” are the corresponding nodes. If the template structure does not have a node that is present in the DOM, then the mismatch routine is called with “d” as the position under which the missing template structure should be added, with a flag set to indicate this special case. If the DOM structure does not have a node that is present in the template, then the mismatch routine is called with “w” as the position under which the missing DOM structure should be added, with a flag set to indicate this special case.

When a DOM node is to be added into the template, the DOM subtree is first normalized into a regular expression by finding repeated patterns in that subtree, in an embodiment. This is similar to how the regular expression is learned for the initial template, in an embodiment. Thus, in an embodiment, the process of adding a DOM node to the template is accomplished by adding, to the template, a regular expression tree corresponding to the DOM node.

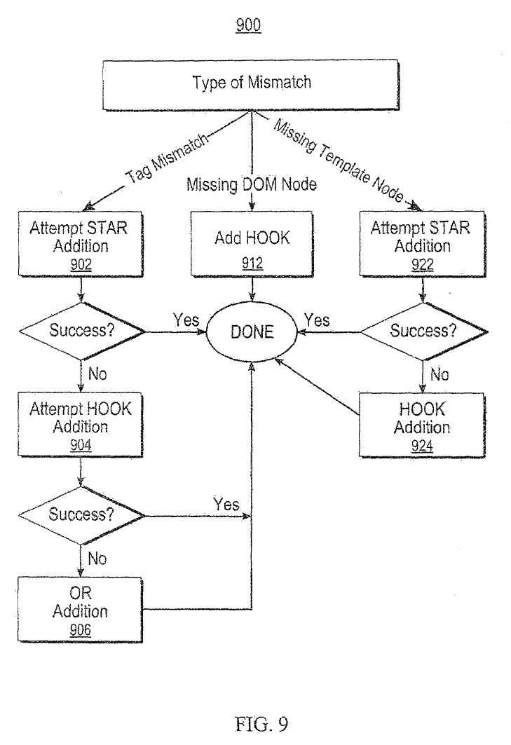

FIG. 9 is an overview of a process 900 of generalizing a template, in accordance with an embodiment of the present invention. The actions taken depend on the type of mismatch. If there is a tag mismatch, then an attempt is made to add a STAR node to the template, in step 902. If STAR addition fails, then an attempt is made to add a HOOK node to the template, in step 904. If the attempt to add a HOOK node in step 904 fails, then an OR node is added to the template, in step 906. The details of each of the three operations are explained below.

If a mismatch occurs because there is no DOM node to match a template node, then the template node that is missing in the DOM is made optional, in step 912. For example, a HOOK node is added as the parent of the template node that is missing in the DOM.

If a mismatch occurs because there is no template node to match a DOM node, then an attempt is made to add a STAR node, in step 922. If STAR node addition fails, then the DOM node that is missing in the template is added to the template as an optional (HOOK) node, in step 924.

The order in which the addition of operators to the template is attempted is in accordance with an embodiment of the present invention. Attempting to add operators in this order may help to generalize the existing structure before adding new changes. However, attempting to add operators in the order depicted in FIG. 9 is not required. In one embodiment, the choice of which operator to add to the template may also be determined based on the extent of change (e.g., cost) that adding operators would induce on the template structure.

### i) Star Addition

STAR addition is used to generalize the template by allowing, but not requiring, repetition of a group of subtrees, in an embodiment. This generalizing of the repetition includes identifying the largest group of subtrees that repeats, in an embodiment. FIG. 10 depicts an example of STAR addition to a template, in accordance with an embodiment. As previously discussed, STAR addition may be performed when a DOM node does not match with a corresponding template node. For example, in FIG. 10, the children of node Z in the original template 1002 are nodes A, B, C, A, D, E. The children of node Z in the DOM 1004 are nodes A, B, C, A, D, A, etc. There is a mismatch at the sixth child node from the left. In the following discussion, the mismatched node in the DOM will be referred to as “d”, and the mismatched node in the template will be referred to as “w”. The sibling in the template 1002 to the left of “w” is remembered as a boundary point (node D in the template 1002 of FIG. 10 is labeled as a “boundaryPt”).

STAR addition may also be called when there is no template node to match a DOM node. For example, the template 1002 of FIG. 10 without the E node may be considered. In this case, the rightmost child of the passed parent node “w” acts as the boundary point. In this case, the mismatch routine would be called on the node Z in the template 1002 (the “passed parent node w”) and the mismatch point A in the DOM 1004. In this case, the boundary point will be the rightmost child of Z (the passed parent node), which is node D (since E does not exist in the template 1102 in this example).

The portion of the template 1002 to the left of the boundary point is searched for an exact match to the subtree of the “d” subtree. In this example, the “d” subtree is represented by the triangle below “d;” therefore, the search for “A” represents a search in the template 1002 for the “d” sub-tree. The search continues to the left to the leftmost sibling of the boundary point. If no match is found, then the STAR addition routine returns as failed, and the mismatch routine attempts to solve the mismatch using a HOOK/OR node addition. In FIG. 10, there are two matches for the “d” sub-tree, which are designated as t1 and t2. More generally, the set of matches is designated as {t₁, t₂, . . . , tₙ}.

All matches in the searched portion of the template 1002 are processed from the leftmost match first. The sequence of siblings from tᵢ to the boundary point are designated as {tᵢ, sᵢ₁, sᵢ₂, . . . , sᵢₖ, boundaryPt}. The sibling subtrees {sᵢ₁sᵢ₂, . . . , sᵢₖ, boundaryPt} are matched with sibling subtrees in DOM in sequence. For example, from t₁ to boundaryPt in the template 1002, the sibling subtree sequence is A, B, C, A, D, which matches with corresponding sibling subtrees in the DOM 1004.

If the matching succeeds from tᵢ to the boundary point (boundaryPt), then a STAR is added over the template nodes from tᵢ to the boundary point ({tᵢ, sᵢ₁, sᵢ₂, . . . , sᵢₖ, boundaryPt}), and the STAR addition routine returns successfully. For example, in the example in FIG. 10, matching succeeds from t₁ to boundaryPt; therefore, a STAR node is added to the new template 1006 as depicted in FIG. 10.

If, however, the matching fails before the boundary point is reached, then next subtree tᵢ₊₁ is considered versus the same starting point in the DOM. For example, the sibling subtrees starting at t₂ to the boundary point would be compared with sibling subtrees in the DOM 1004 starting at the mismatch point to determine whether there is a match. For example, the sibling subtrees in the template 1002 between t₂ to boundaryPt is represented by the sequence [A, D]. The sequence [A, D] would be compared to the DOM starting at the mismatch point. The DOM sequence starting at the mismatch point is [A, B, C, A, D, E].

If no match is found for any sibling subtrees starting at any of the points {t₁, t₂, . . . , tₙ}, then matching is enforced for the sibling subtree sequence starting from the last subtree tₙ by calling a mismatch handling routine recursively. The matching continues further relative to siblings sₙⱼ (calling mismatch wherever applicable). Finally, when the boundary point is reached, a STAR is added over the template nodes from tₙ to the boundary point ({tₙ, sₙ₁, sₙ₂, . . . , sₙₖ, boundaryPt}). The STAR addition routine returns as having succeeded.

Sometimes, a mismatch is “called within itself”. In order to resolve one mismatch (e.g., MMₑₓₜ), there might be another internal mismatch, MMᵢₙₜ that needs to be resolved first. In such a scenario, because MMₑₓₜ is already partially resolved by processing the internal mismatch MMᵢₙₜ, going all the way to the leftmost sibling is not necessary when handling MMₑₓₜ, but only until a closer left boundary point is reached.

### ii) Hook Addition

In one embodiment, if STAR node addition fails, then an attempt is made to add a HOOK operator over a mismatched node. The mismatched node may be a node from the DOM or the initial template. In one embodiment, a one-step look-ahead is used. In another embodiment, a multi-step look-ahead is performed. One-step look ahead refers to stepping through the template or DOM only one-step (e.g., one node) for an exact match. For example, if the template is (A,B,C,D) and the DOM is (A,B,C,E,D), then, in one-step look-ahead, the E can be made optional by adding a HOOK over the E. That is, looking ahead one step is sufficient to determine that the D node in the template has a match in the DOM. Adding the HOOK to the template results in a complete match and also results in a relatively small cost of generalizing the template. However, if the DOM is (A,B,C,E,F,D), then one-step look-ahead may not resolve this mismatch as efficiently as multi-step look ahead. Multi-step look ahead refers to looking ahead more than one step (or node). In the present example, looking ahead at least two nodes would result in a determination that the D node in the template has a match in the DOM. However, looking ahead only a single node would not locate the D node in the DOM. Thus, the generalization to the template using one-step look ahead might incur a greater cost. The cost of generalizing the template is discussed in more detail below. In one embodiment, an attempt is made to add a HOOK operator using one-step look ahead rather than performing multi-step look-ahead.

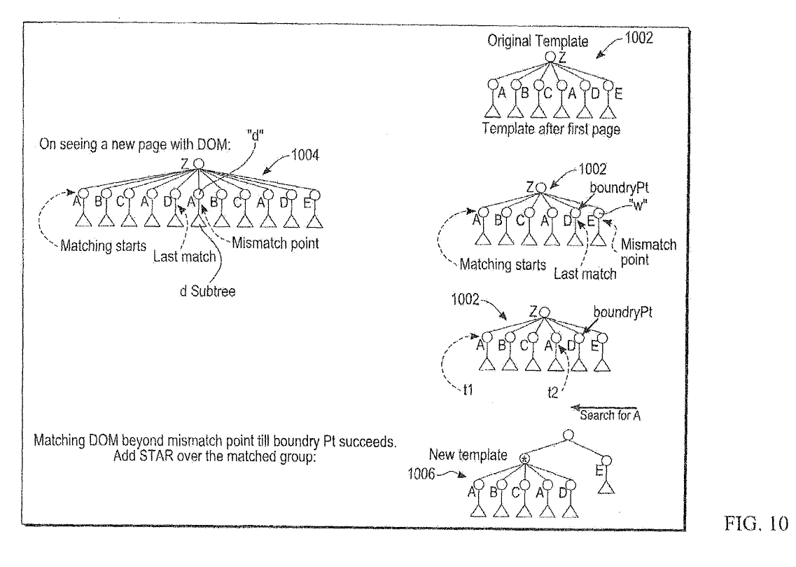

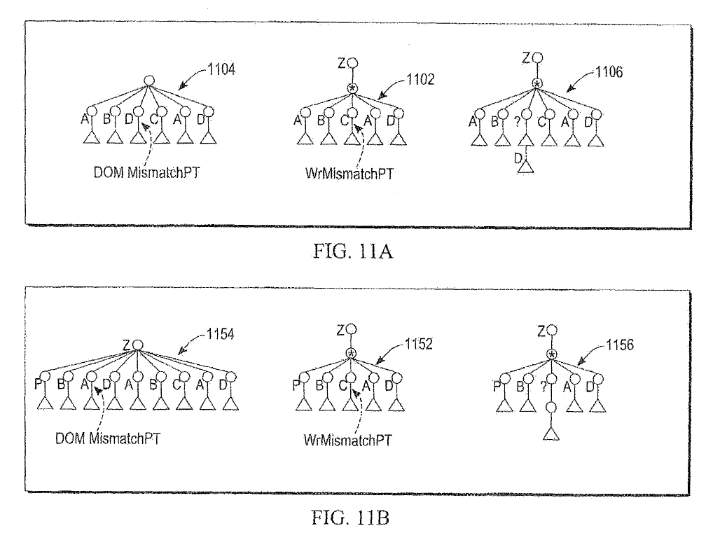

FIG. 11A illustrates an example initial template 1102, example DOM 1104, and a generalized template 1106 that is the result of adding a HOOK operator, in accordance with an embodiment. In FIG. 11A, the mismatched template node is labeled “wrMismatchPt”, and the corresponding mismatched DOM node is labeled “domMismatchPt.”

The following example is presented to illustrate modifying the template 1102 by adding a HOOK node. First, a determination is made as to whether wrMismatchPt matches completely with the next sibling of domMismatchPt. Referring to FIG. 11A, the next sibling of domMismatchPt is the C node to the right of domMismatchPt. If there is a match, then domMismatchPt is added into the template as an optional node (under HOOK) before wrMismatchPt. In this example, wrMismatchPt matches completely with the next sibling of domMismatchPt; therefore, the HOOK node and D node are added to the template as depicted in template 1106.

FIG. 11B illustrates a generalization to a template in the event wrMismatchPt does not match completely with the next sibling of domMismatchPt. In this event, a determination is made as to whether domMismatchPt matches completely with the next sibling of wrMismatchPt. If so, the wrMismatchPt is changed to an optional node. In FIG. 11B, the next sibling of wrMismatchPt in template 1152 is an A node, which matches with the domMismatchPt in DOM 1154. Therefore, the C node in initial template 1152 is changed to an optional node in the new template 1156 by the addition of a HOOK node above the C node. Further, HOOK addition is considered successful.

In some cases, the generalization in both FIG. 11A and FIG. 11B may be possible. In such a case, either option may be performed. If a HOOK node is not added by either options, then the HOOK addition routine returns as failed. In this event, an attempt is made to generalize the template by adding an OR operator.

### iii) OR Addition

OR addition is performed when both STAR and HOOK additions fail, in an embodiment. In one embodiment, OR addition is used as a last resort to enforce matching. The use of OR addition assures that the template will be matched to all of the DOMs in the training set, in an embodiment.

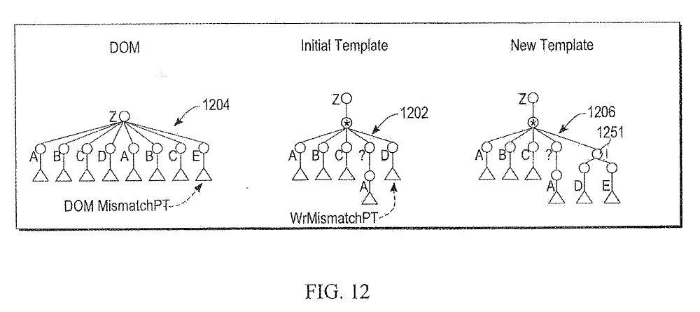

FIG. 12 depicts an example of adding an OR node to generalize a template, in accordance with an embodiment. In the initial template 1202, the children of the Z node are A, B, C, optionally A, and D. Thus, the mismatched nodes are “DomMismatchPt” and “WrMismatchPt”. In the example, a new OR node 1251 is created in the new template 1206, and the mismatched Template node (D) and DOM node (E) are added as children of this OR node 1251.

If the mismatched template node (WrMismatchPt) is already under an OR node in the initial template 1204, or if WrMismatchPt is itself an OR node, then a new OR node is not added to the new template 1206. Rather, the mismatched DOM node (DomMismatchPt) is added as a child of the existing OR node.

### iv) Addition of Operators Across Tree Levels

The operations defined in the above examples to resolve a mismatch work at the same logical level in the template as that of the mismatch point. The “same logical level” means that the mismatch is handled by adding operators at the same logical level in the template. As previously mentioned, for purposes of counting logical levels, operators (e.g., HOOK, OR, STAR) are not counted as a logical level. For purposes of discussion, logical levels will be counted upward when moving towards a leaf node.

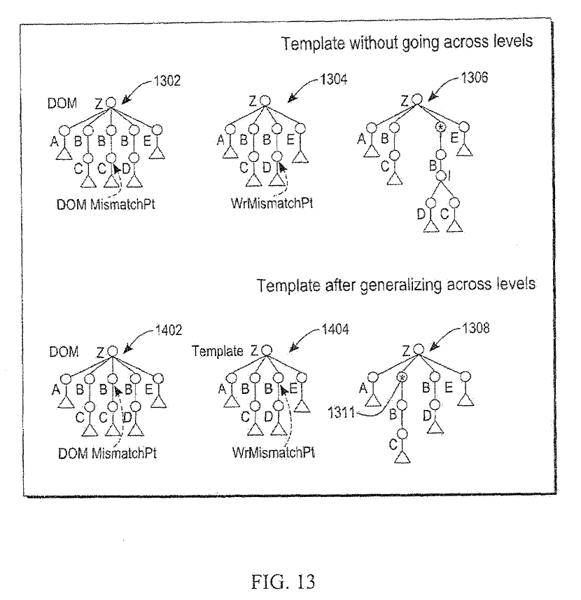

FIG. 13 shows an example DOM 1302 and an initial template 1304, in which there are two different mismatch points. Template 1306 shows how the initial template 1104 could be generalized without going across levels. Note that a STAR operator is added at the same logical level as the mismatch caused by the additional B node in the second logical level DOM 1302. Further, the OR operator is added at the same logical level as the mismatch caused by the additional C node in the third logical level of the DOM 1302. Template 1308 depicts generalizing the template across logical levels, in accordance with an embodiment.

In one embodiment, a set of operations referred to herein as “Cross Level STAR Addition” (CLSA) and “Cross Level HOOK Addition” (CLHA) are added to the template. The CLSA and CLHA are added by examining the initial template and the DOM at a level other than the level at which the mismatch occurred. In one embodiment, higher levels are examined to attempt to resolve the mismatch between the template and the DOM at a higher level.

### Cross Level STAR Addition (CLSA)

When a mismatch occurs, after attempting to add a STAR operator at the same logical level as the mismatch, a determination is made as to whether a STAR operator can be added at a higher level. Referring to FIG. 13 with respect to the mismatch at the third logical level, an attempt to add a STAR operator at the third level will fail. Thus, an attempt is made to add a STAR operator at a higher level. In this example, the parents of the mismatched nodes are examined to determine whether STAR addition is possible at the second logical level. In this example, a STAR operator 1311 can be added at the second logical level. Notably, the template 1308 has been generalized to match the DOM 1302 (i.e., both mismatches have been handled) with the addition of a single STAR operator 1311 at a higher level than at least one of the mismatches. An attempt can also be made to add the STAR operator more than one level away from the mismatch.

### Cross Level HOOK Addition (CLHA)

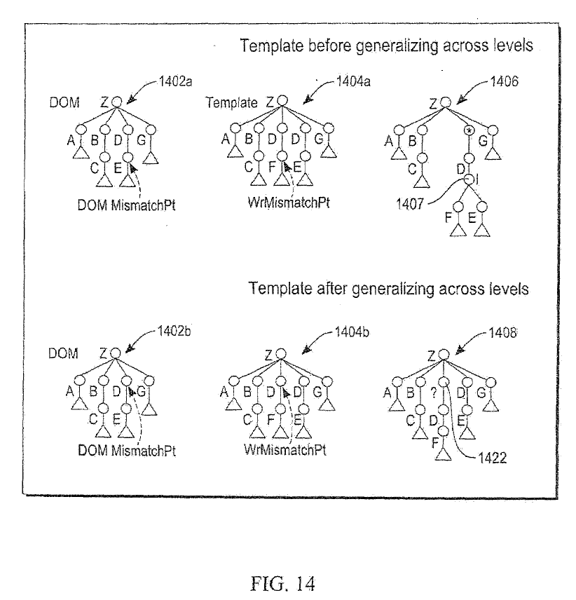

In one embodiment, if attempting to add a HOOK operator at the same logical level as the mismatch fails, then before attempting to add an OR operator at the logical level of the mismatch, an attempt is made to add a HOOK operator at a higher level than the mismatch. FIG. 14 depicts an example to illustrate this embodiment. In the example, there are mismatches between the DOM 1402a and the initial template 1404a at the third logical level. Template 1406 depicts a template that is generalized to match the DOM 1402a without performing CLHA. Notably, an OR operator 1407 has been added to the third logical level of template 1406.

Template 1408 depicts a template that is generalized to match the DOM 1402b by performing CLHA. Notably, a single HOOK operator 1422 has been added at the second logical level in order to modify the template to match the DOM 1402b. In this example, instead of an OR operator being added to resolve the mismatch at the third logical level, the mismatch points are first set to their respective parents to check if CLHA is applicable. Referring to DOM 1402b, the DOM mismatch point at the third logical level is moved to the parent at the second logical level. Referring to template 1404b, the template mismatch point at the third logical level is moved to the parent at the second logical level. In this example, CLHA succeeds. The mismatch points can be moved up by more than one level.

If neither CLSA nor CLHA succeeds, then the mismatch can be resolved by adding an operator at the same level as the mismatch.

### iv) Cost of Generalizing the Template

When the template is modified (or proposed to be modified), the template is said to incur a cost of generalization. This cost is the cost of modifying the template to match the current document completely, in an embodiment. A low cost implies that the current document is similar to the other documents in the training set used to build the template. On the other hand, a high cost implies relatively large differences and possibly that the current document is heterogeneous with respect to the rest of the training documents. In an embodiment, a threshold is specified for the cost wherein the template is not modified to match the current document if the cost would be too high. Thus, documents that are too dissimilar from the rest of the training documents are, in effect, removed from the training set.

The following are example factors that can be used to compute the cost. Use of all of the factors is not required. Each factor can be weighed differently.

1) The size of the changed subtree (number of nodes in the subtree), S. The larger the size of the subtree added/modified, the higher is the cost of change.

2) The height (depth) of the subtree added/modified, H. In principle, on a modified subtree, the nodes added at the top of the subtree have more importance and hence incur higher cost than those at the bottom. This means that a cost of addition of a subtree of size S will be larger if the subtree is a shallow tree (the subtree has lower H).

3) The level in the template which this change occurred, L, computed from the top of the template. The cost decreases exponentially with increasing L. This means that the changes towards the top of the tree incur more cost than those towards the bottom of the tree.

4) The operator added. In one embodiment, the STAR operator does not add any cost, since the STAR operator generalizes the repetition count. In one embodiment, the OR operator induces cost based on whether the OR operator is added as a new node to the template or another disjunction is added to an existing OR node. In one embodiment, the HOOK operator cost depends on whether an existing structure in the template is made optional or a new optional subtree is added to the template.

A particular example of the cost function is Cost=S×10^{1-[(L+H/2)/D]}, D is the overall depth (height) of the template and is used to normalize the numerator L+H/2. There can be many other such functions.

The cost of change is compared against the sizes of the original template and the current DOM. The size of the current template is computed similar to the one used to compute the cost of change—i.e., every node is weighed proportionally to that node's height H in the template. The current page is said to make a significant change to the template if the cost of change induced by the current page is more than a pre-determined fraction (e.g., 30%) of the template and DOM sizes. The template and DOM size can be calculated in many other ways—by simply counting the number of nodes in the template/DOM, by weighing those nodes differently by those nodes' depth in the tree, by relative importance, etc.

### Overview of Extracting Information Based on Document Structure and Characteristics of Attributes

Techniques are disclosed herein for extracting attributes (e.g., title, price, description) from documents such as web pages. The documents have a defined structure such as a DOM. To extract an attribute from a new document, first a set of candidate nodes in the new document are identified based on the nodes' structural positions in the document. The candidate nodes are nodes that might posses the attribute of interest. However, the set of candidate nodes may have “false positives”. That is, some of the candidate nodes might not possess the attribute. Therefore, a set of filters are applied to eliminate the false positives.

The filters are based on characteristics that the attribute has in a set of one or more training documents. For example, in the training document(s), the attribute may be characterized as having the value “bold” for an HTML font property. As another example, the attribute may be characterized as having a contextual format of text 1: text 2. That is, a Name:Value format might appear in the text associated with the attribute. Based on the filtered candidate nodes, the attribute may then be extracted from the document. Thus, both the structural position of nodes in the new document and characteristics of the attribute in a set of one or more training documents are used to identify nodes in the new document that have the attribute of interest.

Prior to identifying the candidate nodes in the new document, a set of filters are learned based on one or more training documents. The filters can be learned based on only a single training document or a few training documents, which are labeled with attributes of interest. For example, a user can identify an attribute by labeling a node in a web page as being a title of interest.

To extract information for a particular attribute from a new document, first, a set of candidate nodes in the new document are determined. This is achieved by determining which nodes in a DOM for the new document map to a template node that is associated with the attribute. For example, based on the learning phase, a determination may be made that the position of particular template node corresponds to the position of a node in a DOM that is known to have a title that is of interest. However, multiple DOM nodes could map to this template node. For example, the DOM could have many “title” nodes; however, not all of these are the title that is of interest. The title DOM nodes that map to the template node are identified as candidates for possessing the attribute of interest.

The candidate nodes are input into the filters, and based on the characteristics that the filters learned about the attribute, the filters score each candidate node. Based on the scores that the filters assigned to each candidate, zero or more of the candidate nodes are selected for extraction. In one embodiment, the candidate nodes are ranked based on the scores. In another embodiment, the candidate node having the highest score is identified for extraction.

In an embodiment, a filter assigns a confidence in a learned characteristic, based on analyses of the consistency of the characteristic across different pages. For example, if a filter indicates that a title is nearly always located in the third row of a table, then the filter assigns a higher confidence to this characteristic than if the filter learns that the title is located in the third row about 65 percent of the time.

Even if incremental changes are made to the structure of new documents, nodes that posses the attributes can still be reliably identified. For example, the structure of a shopping web page might change by the addition of a new row to a table. The new and old rows will both map to the template because they will both have a “td/tr” format. However, the characteristics that were learned by the filters, such as the color of the title or the context of the title, can be used to accurately determine which of the rows has the attribute of interest.

### Process for Learning Characteristics of Attributes and Structual Position of Attributes

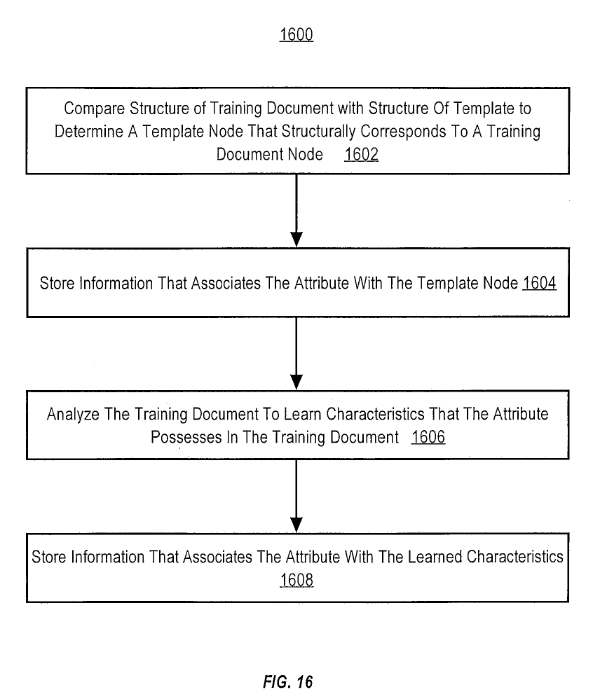

FIG. 16 depicts a flowchart of a process 1600 for learning characteristics of attributes, as well as a structural position of an attribute, in accordance with an embodiment of the present invention. In step 1602, a structure of a training document is compared with a structure of a template to determine a node in the template that structurally corresponds to a particular node in the training document. The particular node in the training document has associated therewith an attribute. In step 1604, information is stored that associates the attribute with the node in the template. Steps 1602 and 1604 are achieved by capturing annotations from a DOM and transferring them to a template, in an embodiment. Only one or a very few pages need to be annotated for the extraction system to be able to extract from the rest of the pages with very high levels of accuracy.

There are multiple ways in which to capture and transfer annotations. In one embodiment, a human identifies attributes of interest from web pages. The human may mark relevant attributes on a webpage using an annotation tool. For example, using the annotation tool, the user may highlight a section of a web page and label the highlighted section with an annotation such as “title”, “description”, “text”, “price”, “postal code”, “name”, “rating”, etc. These web page annotations can be transferred as annotations on to the corresponding nodes in the DOM structure of the webpage in accordance with known techniques.

In one embodiment, automated annotation techniques are used to augment the human-provided annotations. Automatically annotating the DOMs can be based on information on the page or other appropriate pages. Examples of information that may be used to automatically annotate the page are data represented in a pre-defined schema, such as key-value pairs, labeled columns, etc. Other hints, such as links into the page from a listing page, like a browse page or a search result page, are sources of annotation. In still another embodiment, no human annotation is performed.

In one embodiment, the template nodes are annotated with attributes when the template is learned based on a set of training documents. For example, a training set of documents may be used when generalizing the template as discussed in the section “GENERALIZING THE TEMPLATE TREE BASED ON A TRAINING SET OF DOCUMENTS.” A user may annotate nodes of interest in one or more of these training documents. During the template matching phase, the attribute annotations on the DOM nodes are mapped to the template. Thus, the template nodes that structurally correspond to DOM nodes are annotated with attributes of interest.

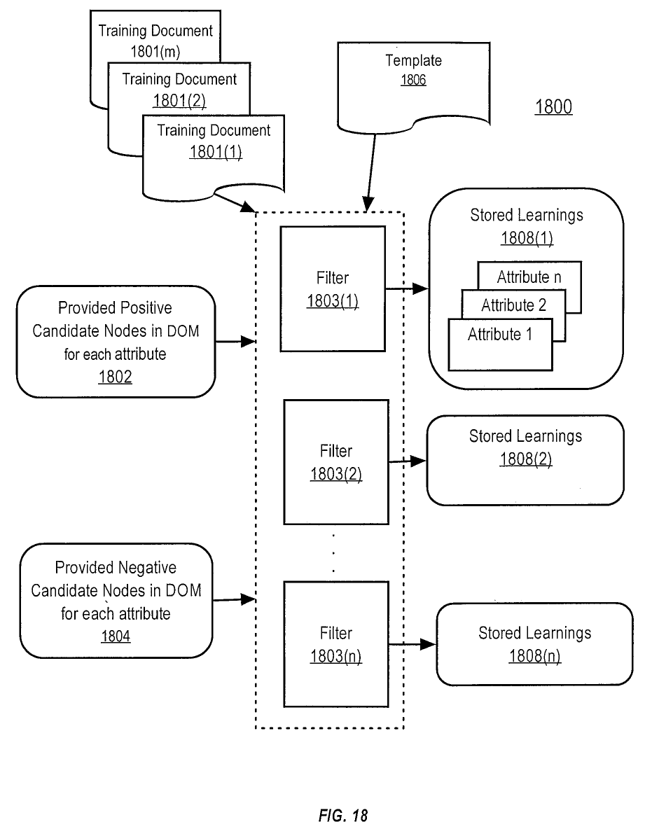

In step 1606, the training document is analyzed to learn characteristics that the attribute possesses in the training document. In one embodiment, in step 1608, information is stored that associates the attribute with the learned characteristics. FIG. 18 depicts a system 1800 that learns characteristics of attributes, in accordance with an embodiment.

### Process for Extracting Attributes Based on Learned Attribute Characteristics and Structural Position of Attributes

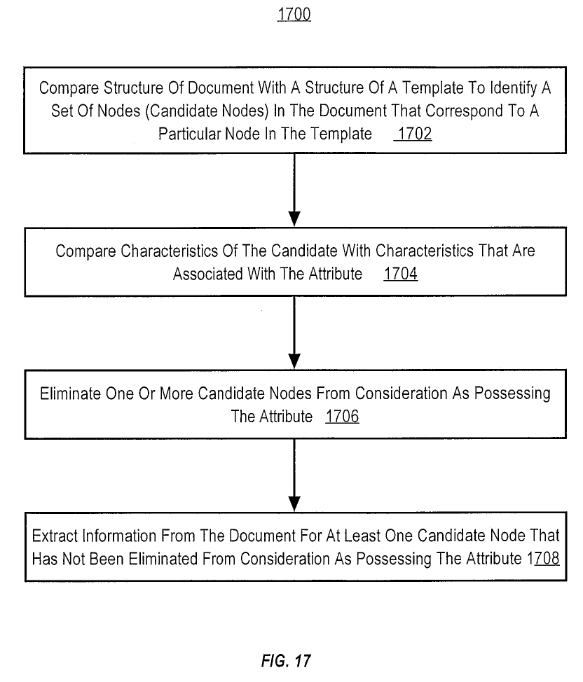

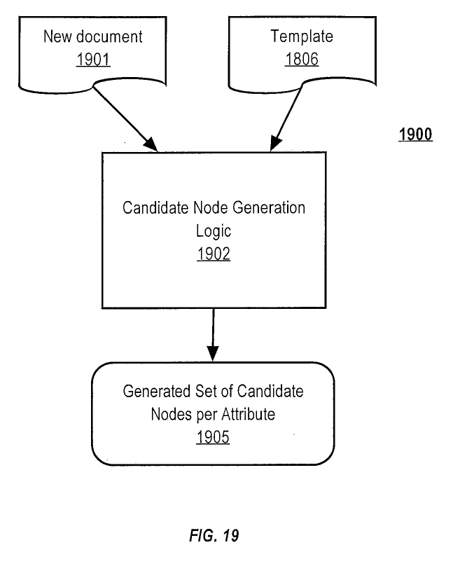

FIG. 17 illustrates a process 1700 of extracting attributes, in accordance with an embodiment. In step 1702, a structure of a document is compared with a structure of a template to identify a set of document nodes that correspond to a particular node in the template. Step 1702 results in generation of a set of candidate nodes. FIG. 19 depicts a system 1900 for generating a set of candidates, in accordance with an embodiment.

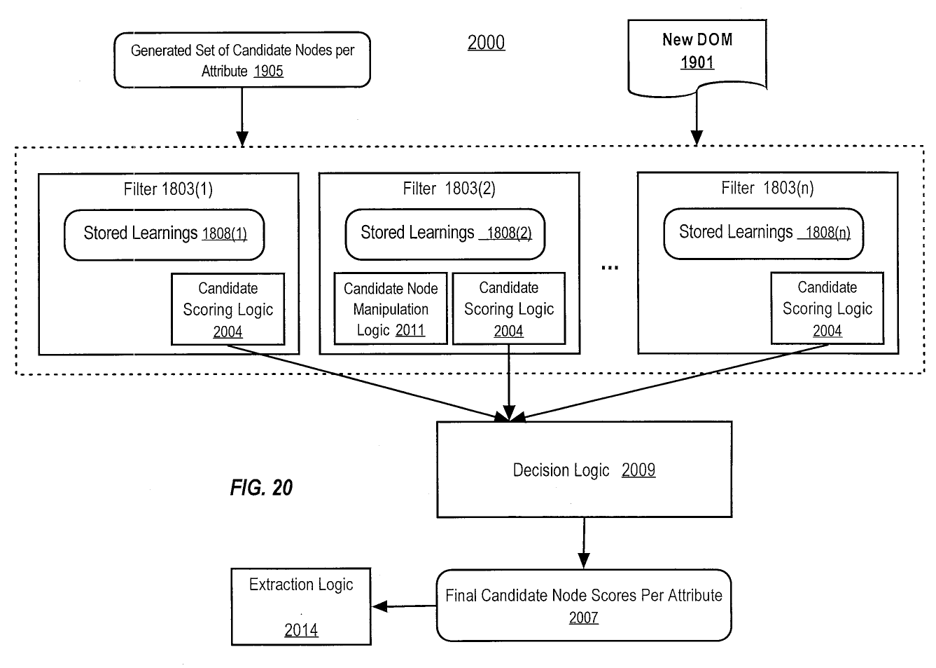

In step 1704, characteristics of the candidate nodes are compared with characteristics that are associated with the attribute. The characteristics are those learned in step 1306 of process 1300, in an embodiment. In step 1706, at least one of the candidate nodes is eliminated from consideration as possessing the attribute, based on the comparison of step 1704. Step 1706 describes the case in which at least one candidate node is eliminated. Under some circumstances, no candidate node might be eliminated from consideration. FIG. 20 depicts details of a system that can be used to eliminate candidates during an extraction phase, in accordance with an embodiment.

In step 1708, information is extracted from the document for at least one candidate node that has not been eliminated from consideration as possessing the attribute. Step 1708 describes the case in which there is information to be extracted from the document for at least one candidate node. Under some circumstances, there will not be information to extract for any of the candidate nodes that remain.

### System for Learning Attributes Characteristics

FIG. 18 depicts a system 1800 for learning attribute characteristics, in accordance with an embodiment. In this embodiment, each filter 1803(1)-1803(n) learns, for each of a number of different attributes, a set of one or more characteristics that attribute possesses in a set of one or more training documents 1801(1)-1801(m). For example, filter 1803(1) might learn HTML properties that a title has in each of the training documents 1801(1)-1801(m). Examples of HTML properties include, but are not limited to, font color, size, stylesheet class, etc. As another example, filter 1801(2) might learn contextual characteristics of the title, as the title appears in the training documents 1801. An example of a contextual characteristic is that the title might have a format of term1:term 2. That is, the title appears in a Name:Value format, where the Value is the actual title and Name is the identifying context.

A filter 1803 is a module that works to reduce the false positives from a set of generated candidates for an attribute. In the learning phase, each filter 1803 inputs a set of positive candidates (PosCands) and possibly a set of negative candidates (NegCands). The negative candidates are optional. A PosCand is a node that has been marked in a training document 1801 as having the desired attribute and a NegCand is a node that the user has marked as spurious. For example, a user identifies a particular title in a web page and annotates the title as a PosCand. The user might annotate a different title in the training document as a NegCand.

The PosCands and the NegCands in the training document(s) 1801(1)-1801(m) map to node(s) in the template 1806. The template 1806 is a tree structure that has been generalized to match the structure of a set of structurally related training documents, in an embodiment. Multiple nodes in the training document 1801 might map to the same node in the template 1806. Some such training document nodes might not be labeled as either a PosCand or a NegCand. These document nodes that map to the same template node as either a PosCand or a NegCand are referred to as unlabeled nodes (UnlabCands).

For example, a filter for a price attribute may be considered. A PosCand is a training document node that the user has selected as having the price attribute. Because documents such as web pages may have repeating patterns, there can be more than one training document node that maps to same template node. Because the user has not annotated such nodes, whether or not the nodes have the price attribute is unknown. NegCands set can be formed in cases where the user specifies the undesirable nodes as well.

The outputs of each filter 1803 are “stored learnings” 1808. The filters 1803 learn on a per attribute basis. At least one of the filters 1803 is able to assign confidence based on analyses of the consistency of the filter's output across different pages. In other words, the confidence is based on how repetitive the filter output is for different training documents that are eventually considered to possess a particular attribute. For example, if a filter 1803 indicates that a title is nearly always located in the third row of a table, then the filter 1803 may assign a higher confidence than would be assigned by a filter 1803 that indicates that a title is located in the third row about 65 percent of the time. The filter 1803 can assign a confidence on a per attribute basis, or a confidence that is independent of attribute. For example, the filter 1803 might work quite well for a title attribute, but not for an address attribute. Notably, a filter 1803 also can assign a different weight for each cluster of documents. Examples of different types of filters are described below.

### Candidate Generation for a Particular Attribute

FIG. 19 depicts a system 1900 for candidate generation, in accordance with an embodiment. The candidate generation logic 1902 determines which nodes in the new document 1901 are candidates for possessing a particular attribute. The new document 1901 is a document that is structurally related to the training documents used to learn the characteristics of the attributes, in an embodiment. A clustering algorithm could be used to determine which documents are structurally related.

For each attribute of interest, the candidate generation logic 1902 outputs a separate set of candidate nodes from the new document 1901. The new document 1901 is compared with the template 1806 to find the candidate nodes. In particular, at least one of the nodes in the template 1806 is associated with one or more attributes of interest. Steps 1602 and 1604 of process 1600 describe one embodiment for associating a template node with the attribute of interest. The candidate generation logic 1902 compares the structure of the new document 1901 with the structure of the template 1806 to identify candidate nodes in the new document 1901. All these candidate nodes are considered as unlabelled candidates (“UnlabCands”) set for the respective attributes, in an embodiment.

In some cases, the attribute of interest may cover multiple nodes in the new document 1901. In such cases, the lowest common ancestor (“lca”) node may be marked as the candidate node and the actual set of nodes is described by mentioning the start and end paths from the lca node. A start (or end) path is a series of node identifiers from the lca node to the start (or end) position of the actual set of nodes.

### System for Extracting Attributes

FIG. 20 depicts a system 2000 for extracting attributes, in accordance with an embodiment. The system 2000 filters a set of candidate nodes 1905 to determine which candidate node or nodes are most likely to possess attributes of interest. Each filter 1803 uses the stored learnings 1808 to score each candidate node. The score is a measure of the confidence that a filter 1803 has that a candidate node possesses the attribute. For example, the score defines a likelihood that a particular candidate node is a title of interest. These scores are provided to the decision logic 2009, which determines a final score for each candidate node on a per attribute basis. The final scores 2007 are provided to the extraction logic 2014, which extracts information associated with each of the attributes from the new document 1901.

### Example Filters

For purposes of illustration, this section describes a few example filters 1803. During the extraction phase, some of the filters 1803 output a score that is based on a probability that a candidate node possess an attribute of interest. Other filters 1803 perform a “text manipulation”, such as extracting a relevant portion of the text associated with a candidate node. The scoring filters 1803 may base their analysis on the extracted portion of the text, although a scoring filter could also analyze non-extracted text. A filter that performs text manipulation can also output a candidate score.

### A) Property Based Filter

From the given PosCands, the Property Based Filter finds values of the given format property (e.g., HTML-based text-formatting properties, such as font color, size, stylesheet class, etc.) and stores the confidence of the particular value of the given format property (hereafter referred to as a (property, value) pair) across pages. The confidence of a (property, value) pair (p, v) in determining a PosCand may be defined as the probability of the candidate being a PosCand given that the property p takes a specific value v [Pr(class=+ve|property p=value v)]. As an example, the property based filter might learn that bold font is a positive property, blue color is a positive property, red color is a negative property, etc. More particularly, the filter may learn that if a candidate node has a blue color, then there is an “x” percent probability that the candidate node has the attribute of interest. Sufficient statistics may be kept to count the number of candidates in which the property was marked as positive/negative by the user such that the probabilities can be learned with desired accuracy.

### B) Position Based Filter

The Position Based Filter finds the position of the candidate among the candidates generated under the lowest containing STAR node of the template, in one embodiment. As previously discussed, a STAR node in a template indicates that multiple occurrences of the underlying template structure are allowed. Hence, if a candidate node maps to a template node under a STAR node, there are potentially many other DOM candidate nodes that map to the same template node. The relative position of the correct candidate in this set is learned by the Position Based Filter. As a particular example, a table in the document may have many rows. Each row is represented by a separate DOM node. However, the template has STAR node and a single node under the STAR to represent that any number of rows are allowed at that structural position. Similar to the Property Based Filter, sufficient statistics may be kept as to where the user-marked PosCands or NegCands are found at a particular DOM node. The confidence may also be determined in a similar fashion, as Pr(class=+ve|position=value v)].

### C) Range Pruner

The Range Pruner learns the relative range position of the required text associated with the attribute. The range is defined as the start and end path under the candidate node and the word offsets within the start and end nodes. The learning may be generalized relative to node boundary and number of siblings. The Range Pruner ensures extraction of correct text where a set of nodes form the required text.

### D) Contextual Filter

The Contextual Filter finds and learns the context around the attribute of interest and outputs a candidate score based on the learned context. Due to the presence of optional information, the position of the desired candidate (in a set of generated candidates) can change from one page to another. For example, the table row that contains a price attribute may vary from one page to the next. Therefore, the position based filter may have a low confidence.

In such cases, the contextual filter may help to detect the correct candidate. An example of such a filter is a Name-Value Pair (NVP) filter. A NVP may occur either as a table or in free text. The table-based NVPs either have names in one column and values in the other (“column major headers”), or have table headers as names and elements in the table as values (“row major headers”). Text-based NVPs have names and values as free text often separated by ‘:’ with names being bold occasionally.

Table based NVP Filters search for a table with row major or column major header, while text based NVPs search for presence of name nodes near the value node and subsequently rely on the Range Pruner to extract the correct text. The presence of a learned context around a candidate on a new page will boost the candidate's overall score. The context filter may be a very strong filter that allows accurate extraction of attributes even if the position of the required text for the attribute varies from one page to the next.

Another kind of Contextual filter is a Prefix-Suffix filter that learns the text that precedes (or succeeds) the text of interest. On finding the preceding and succeeding text on a new page, the content within these is selected as the desired text.

### E) Regex Filter

The Regex Filter checks whether text associated with an attribute matches a desired data format (e.g., regular expression). Candidates having the desired data format may receive a boost to the scores generated by other filters 1803. The regular expression may be given as a configurable input or, alternatively, may be learned based on the PosCands or NegCands given to the Regex Filter. An example of the use of the Regex Filter is to learn that a date attribute has the format “dd/mm/yy”, wherein dd is a value between 1 and 31, mm is either a value between 1 and 12 or a textual value corresponding to one of the months, and yy is an integer between 0 and 99.

### F) Tag-Specific Filter

A filter may perform operations other than scoring. Sometimes, the desired extraction is not of the text that appears within an HTML tag, but of some other aspect of the tag. For example, when an image is selected, a ‘src’ attribute may need to be extracted. Similarly, for a hyperlinked text, extracting the location to which the link points (the ‘href’ attribute) may be more appropriate. The Tag-specific filter performs this task of extracting the appropriate attribute from the specified tag.

### G) Text Manipulation Filter

In one embodiment, a filter performs a text manipulation operation. An example of a text manipulation operation is to extract a portion of the text. As a particular example, for a node having the text “this camera sells for $300.00”, the text “$300.00” is extracted. Other filters 1803 may perform their analysis based on the manipulated version of the text.

### Automated Creation or Template

Advantageously, certain embodiments of the invention provide for the automated creation of templates. In such embodiments, a person initially annotates a small number (for example, one or a few) of training documents. One or more templates may be created based on the small number of training documents. Thereafter, as shall be explained in further detail below, information extraction engine 124 (shown in FIG. 1) uses the one or more templates to create a large number of templates for a large number of clusters in an automated fashion without human intervention.

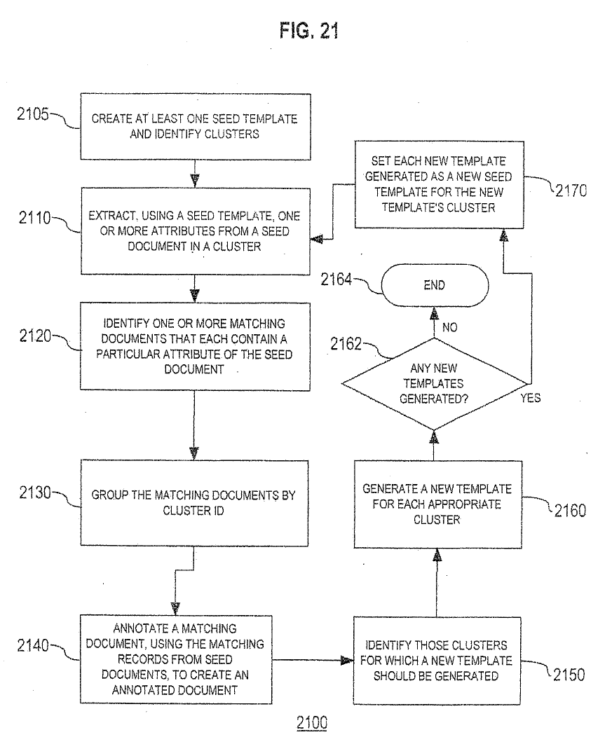

The automated creation of templates will be explained in further detail below with reference to FIG. 21, which is a flow chart 2100 illustrating the steps of creating templates according to an embodiment of the invention. Unless otherwise specified, except for the manual annotation of documents performed in step 2105, information extraction engine 124 performs each step depicted in FIG. 21.

### A) Initial Creation of at Least One Sed Template and Identication of Clusters

Initially, in an embodiment, in step 2105, from among a large collection of documents (such as web pages on the World Wide Web), documents that have similar structural characteristics are identified and subsequently grouped into a cluster. Many clusters of documents whose members have similar structural characteristics may be created from the large collection of documents.

For example, in an embodiment where web pages are grouped into clusters, all web pages at web site ABC that have similar structural characteristics may be grouped into one cluster, and all web pages at web site XYZ that have similar structural characteristics may be grouped into another cluster. Each cluster of documents only includes web pages from a single web site, although a single web site may comprise web pages arranged into one or more cluster of documents.

Information extraction engine 124 may create clusters using a variety of techniques, including those techniques discussed in U.S. patent application Ser. No. b 11/481,809, filed on Jul. 5, 2006, entitled “TECHNIQUES FOR CLUSTERING STRUCTURALLY SIMILAR WEB PAGES BASED ON PAGE FEATURES” or in U.S. patent application Ser. No. 11/481,734, filed on Jul. 5, 2006, entitled “TECHNIQUES FOR CLUSTERING STRUCTURALLY SIMILAR WEB PAGES.”

After each cluster of documents has been identified, each document in each cluster may be assigned a cluster identification (or simply a “cluster id”). A cluster id is data that identifies a particular cluster to which a document belongs.

In an embodiment, also in step 2105, a user manually annotates a small number of training documents in one or more clusters of documents. Thereafter, a template (hereafter referred to as a “seed template”) is created for each cluster containing a training document based on the one or more training documents for that cluster. In an embodiment, after a user has manually annotated the one or more training documents, information extraction engine 124 may create a seed template for each cluster containing training documents using the techniques discussed above in the sections entitled “Template Creation” and “Generalizing the Template based on a Training Set of Documents.”

After the clusters have been identified and the one or more seed templates are created, one or more attributes are extracted from documents as shall be explained in further detail below.

### B) Extracting Attributes

In step 2110, one or more attributes are extracted from one or more documents (individually referred to as a “seed document”) using the seed template. In an embodiment, a seed document from which one or more attributes are extracted from in step 2110 may correspond to a web page, although the document may be any type of structured document, such as an XML document. Information extraction engine 124 extracts the one or more attributes from a seed document using the seed template in an embodiment.

The one or more attributes extracted in step 2110 may correspond to any particular content feature which may be included in the document. For example, an attribute may correspond to a title of a product, the price of a product, or a description of a product. A set of related attributes constitute a record. To illustrate, a particular record about a product may be comprised of information about the title of the product, the price of a product, and the description of the product. As a result, for ease of explanation, the one or more attributes extracted from a seed document in step 2110 shall be collectively referred to as “the seed records,” as a portion of the one or more attributes extracted in step 2110 may constitute a record.

Attributes may be extracted in step 2110 using the techniques discussed in a prior section entitled “System for Extracting Attributes.” After the seed records have been extracted from seed documents of a cluster in step 2110, one or more other documents outside of the cluster that each contains a seed record are identified, as shall be explained below with reference to step 2120.

### C) Identifying Matching Documents

In step 2120, a collection of documents are searched, and one or more other documents (hereafter individually referred to as a “matching document”) that contain at least one attribute present in the seed records are identified. A matching document identified in step 2120 may additionally contain two or more attributes and/or one or more records present in the seed records. Information extraction engine 124 may perform step 2120 in an embodiment.

Embodiments of the invention operate under the observation that certain attributes and records appear similarly across different web sites. For example, two different shopping web sites will likely carry the same product. Thus, a record displayed on a first web page on a first web site may be found on a second web page on a second web site by matching attributes of a record extracted from the first web site with the content of the second web page on the second web site. Thus, in step 2120, a collection of documents are searched to identify one or more matching documents, i.e., those documents that contains at least one attribute of the seed records extracted in step 2110.

Each matching document identified in step 2120 is in a different cluster of documents than the document from which the seed attributes were extracted in step 2110. For example, if the seed records were extracted from a web page from a particular web site in step 2110, then in step 2120, the matching documents identified may correspond to web pages of web sites other than the particular web site.

For example, a particular seed record extracted in step 2110 might comprise four attributes, namely product name, product price, product description, and product manufacturer. In step 2120, automated processes look for a matching document that contains the same four attributes. If the four attributes are found in a matching document, then the matching document is assumed to contain data about the same product as the particular seed record. Certain embodiments may require that the words comprising an attribute of a record appear in the same order for a match to be made, e.g., if a product title contains 5 words, then the same 5 words must appear in the same order on a document for a match to be made. Advantageously, as shall be discussed in further detail in subsequent steps of FIG. 21, the knowledge that the matching document contains an attribute or record similar to one of the seed records is useful because this knowledge enables the matching document to be annotated in an automated fashion using the seed template.

In an embodiment, noise may be reduced by requiring that, for a particular document to be matched, the document must have a minimum level of similarity with a seed record. For example, a particular record might comprise the following attributes: title, author, news content, and newspaper. If only the title matches, but none of the other attributes of the record match, then the document is not considered to match, because in this embodiment, a document must contain an entire record for the record to be considered a matching document. Embodiments of the invention may employ different minimums level of similarity.

In an embodiment, the collection of documents searched in step 2120 corresponds to a large number of web pages available on the Internet. However, in other embodiments, the type of documents searched in step 2120 may correspond to any type of document, and need not necessarily be a web page.

Embodiments of the invention may employ different techniques to identify near duplicate representations of seed records in different document. Various techniques for doing so will now be presented.

### i) Indexing

In an embodiment, a DOM tree is created for each document being searched. A DOM node identifier (a “DOM-node-id”) is assigned to each DOM node of a document. This DOM-node-id uniquely identifies the DOM node and the corresponding document in which the DOM node occurs. An inverted index is created at the level of DOM nodes by mapping content to the DOM-node-id in which the content occurs. The inverted index may be created either by a conventional sort-based approach or using the MapReduce framework introduced by Google, Inc. of Mountain View, Calif. In the sort-based approach, word/DOM-node-id statistics pairs are collected in the first phase, and a disk-based sort method is used to aggregate statistics of a word across all that word's occurrences in the next phase. The same algorithm can be implemented using the MapReduce framework with the advantage of ease of parallelism across a large number of compute nodes. Once the inverted index is created, the attributes extracted in step 2110 may then be quickly looked up in the inverted index to find matching documents. Therefore, the lookup cost to find the set of matching documents is in the order of number of query terms.

### ii) Fuzzy Similarity Metrics

In an embodiment employing fuzzy similarity metrics, a DOM tree is generated for each document being searched. The content inside each DOM node of each document being searched is also extracted.

A pair wise comparison between the extracted records (seed records) and each document being searched can be performed using fuzzy similarity metrics, including but not limited to cosine similarity, edit distance, Jaccard similarity, and Dice similarity. Fuzzy similarity metrics are different notions to represent the similarity between two pieces of text. Pair wise comparison is an expensive operation (the cost is of the order of the number of DOM nodes multiplied by the number of the extracted attributes) that involves performing the chosen fuzzy match algorithm for every (DOM node, extracted attribute) pair.

This approach may be implemented through a data cross-product operation followed by an evaluation of every cross product pair. The MapReduce framework enables parallelizing the cross-product and the evaluation steps across a large number of compute nodes. However, the cross-product algorithm can be implemented on a single machine, within or outside of the context of a database engine.

### iii) Fingerprinting

In an embodiment employing fingerprinting, a DOM tree is generated for each document being searched. The content for each DOM node of each DOM tree is represented as a fingerprint. A fingerprint is a constant length representation of the key features of the content. One of a variety of fingerprinting algorithms, such as shingling and simhash, may be employed by embodiments to generate a fingerprint. A fingerprint is also created for each seed record.

A characteristic of a fingerprinting algorithm is that two pieces of text having only minor variations in content will have the same fingerprint value. In this approach, fingerprints are generated for content in each DOM node for all documents being searched. A fuzzy similarity metric is defined that determines how much variation in the fingerprinting patterns can exist for their corresponding pieces of text to be considered the same. A sort-merge join algorithm may then be used to find matching attributes and the content fingerprints which are the same as defined by the fuzzy similarity metric. The fingerprint generation and the sort-merge join algorithms can be implemented on a single machine. However, both operations can also be parallelized using the MapReduce framework.

### iv) Trie-Based Lookup

In an embodiment employing trie-based lookup, the content from all DOM nodes in all the documents being searched is loaded into a trie data structure, such as a Patricia trie data structure. The leaf nodes of the trie data structure represent DOM nodes containing the same content.

An extracted attribute can be matched into the trie data structure (using either an exact match or using a fuzzy match based on string similarity distance metrics like edit distance) to identify matching leaf nodes, thereby identifying the DOM nodes that match the attribute. The matching DOM nodes may be annotated with the attribute label. This approach may be implemented using parallelism explicitly handled by multiple compute jobs running on different portions of the data or by using the MapReduce framework to manage the data parallelism.

The above four approaches for identifying near duplicate representations of seed records in different documents are merely exemplary of several embodiments, as other embodiments may perform other techniques, not discussed above, for identifying near duplicate representations of seed records in different documents. Once one or more matching documents are found, the matching documents may be grouped by their cluster id, as shall be explained in further detail below with reference to step 2130.

### D) Grouping Matching Documents by Cluster Id

In an embodiment, in step 2130, the one or more matching documents identified in step 2120 are grouped by their cluster id. Each of the “groupings” of matching documents corresponds to a particular cluster identified in step 2105; however, each grouping of matching documents does not contain any documents that are part of a cluster that are not matching documents. For example, assume that a cluster identified in step 2105 consists of five documents named A, B, C, D, and E, and further assume that two of the five documents (namely A and B) of the cluster were identified as matching documents in step 2120. Therefore, in this example, the grouping of matching documents created in step 2130 would contain A and B, as those documents were identified as matching documents in step 2120, but not C, D, and E. Noise filtering processes may be performed on each of the groupings of matching documents created in step 2130 to eliminate certain groupings from further consideration if it is determined their inclusion may result in an unacceptable level of noise.

After the matching documents identified in step 2120 are grouped by their cluster id into one or more groupings of matching documents, at least the matching documents identified in step 2120 are annotated using the matching records, as shall be discussed in more detail below with reference to step 2140.

### E) Annotating Matching Documents Using a Sed Template

In step 2140, each matching document identified in step 2120 is annotated using the matching seed records to create an annotated document. The annotation performed in step 2140 is unsupervised, i.e., the annotation is performed by an automated process without human intervention. Information extraction engine 124 may perform step 2140 in an embodiment.

In an embodiment, in addition to annotating each matching document identified in step 2120, information extraction engine 124 may also annotate one or more other documents in one or more clusters. For example, information extraction engine 124 may ensure that a minimum number of documents in each cluster arranged in step 2130 are annotated in step 2140. Documents belonging to a cluster which were not identified as matching documents in step 2120 may be identified as belonging to the cluster based upon the cluster id for the cluster. For example, to identify all documents of a cluster, regardless of whether a document was deemed a matching document in step 2120, a search may be performed to retrieve all documents associated with a cluster id for the cluster. In this way, additional documents of a cluster there were not identified as matching documents in step 220 may also be annotated in step 2140.

To annotate a document, portions of the document that are desired to be extracted are identified. In an embodiment, this may be accomplished by identifying where the attributes that are to be extracted from the document are located.

In an embodiment, a matching document may be annotated using the seed records extracted from a seed template. Information extraction engine 124 compares a matching seed record with a structure of a matching document to identify a set of DOM nodes in the matching document that correspond to attributes in the matching seed record. The content in the matching seed record is used to annotate the corresponding portion of the matching document. Data that identifies a data type associated with attributes present in said set of document nodes is stored. Information extraction engine 124 may store data that identifies the location of each attribute to be extracted from a document and identifies the type of attribute to be extracted. For example, information extraction engine 124 may store data that identifies the location of a title of a product, price of a product, and description of a product in the document.

While the step of 2140 is depicted as being performed subsequent to step 2130 in FIG. 21, some embodiments may perform step 2140 prior to, or in parallel with, step 2130. After the performance of step 2140, step 2150 is performed, as shall be explained in more detail below.

### F) Identifying for Which Grouping of Matching Documents a New Template Should Be Generated

In step 2150, the clusters, corresponding to the groupings of matching documents created in step 2130, for which a new template should be generated are identified. As the steps of FIG. 21 may be performed repeatedly in sequence, noise introduced in the process will decrease the accuracy of the generated templates as the process each iterated. Accordingly, the purpose of step 2150 is to reduce or eliminate noise by only generating templates for clusters having characteristics that suggest any generated templates for those clusters will not introduce unwanted noise into the process. Since the process depicted in FIG. 21 is iterative, noise added in any stage would percolate to later stages to create additional unwanted noise.

Embodiments may employ many different considerations in determining whether a new template should be generated for a particular cluster associated with a grouping of matching documents created in step 2130. In one approach, a new template is generated for a cluster only if there is a high degree of correlation in the XPath location of records in documents of the cluster. In this way, a specified level of correlation should exist between portions of a tree representation for documents in a particular cluster of documents for a new template to be generated for the particular cluster.

According to another approach, a new template is generated for a cluster only if a minimum number of documents in the cluster are present.

According to another approach, a new template is generated for a cluster only if there are no repeated words detected in the seed records extracted from documents in that cluster. For example, if a seed template extracts the word “technology” from all documents in a cluster, then the word “technology” may not correspond to an attribute that is desired to be extracted, but instead, may form part of the structure of the document that is common across all documents of the cluster. Consequently, if a repeating word is detected in the seed records extracted from one or more training documents, then a new template is not generated for the cluster associated with those training documents in an embodiment.

In an embodiment, a list of cluster ids associated with cluster for which templates have been generated is maintained. It is advantageous to only create each template for a cluster once. By checking the list, it may be determined that a template for a grouping identified in step 2130 should not be generated during the current iteration as it has already been generated. In this way, only one template for each cluster need be created.

After the clusters for which a new template should be generated are identified, the new templates are generated in step 2160.

### G) Generating a New Template

In step 2160, a new template is generated for each cluster identified in step 2150 for which a new template should be generated.

Multiple techniques may be used to generate new template. Each cluster identified in step 2150 has at least one annotated matching document as a member. Annotated documents within a cluster of documents may be used by information extraction engine 124 to generate a new template for the cluster of documents. Embodiments of the invention may generate a new template for each cluster identified in step 2150 using the techniques discussed in the prior section entitled “Template Creation.”

In an embodiment, each new template generated in step 2160 is stored on a volatile or non-volatile computer-readable medium, such as storage medium 130. For example, each new template generated in step 2160 may be incorporated into extraction templates 128.

Embodiments of the invention may determine that a particular new template (a) should not be generated in step 2160 or (b) should not continue to be used after it the new template is generated. There are a variety of different reasons why a particular embodiment may conclude that a particular template does not qualify for generation. Several reasons have already been discussed above. As another illustrative reason, once a template is generated in step 2160, the template may be tested on all documents in the cluster associated therewith to determine whether the newly generated template performs a legitimate extraction of information from documents of the cluster. The determination of whether a template performs a legitimate extraction could be made in a variety of different ways in different embodiments. In an embodiment, the determination of whether a template performs a legitimate extraction may involve a determination of whether the extracted records show a high degree of dissimilarity of content. If there is too much similarity of content in the extracted records of a cluster, then the template might have extracted portions of the documents that are not meant to be extracted, such as the web page template. In such a case, if there is too much similarity of content found in the extracted records of a cluster, information extraction engine 124 may conclude the template is not as precise as the template should be, and the template may be disqualified from further use.

In other embodiments of the invention, the determination of whether a template has performed a legitimate extraction may involve a determination of whether there is a low variance of similarity in the characteristics of the extracted content (for example, low variance in length of the extracted fields). In such a case, if there is not low variance of similarity in the characteristics of the extracted content, information extraction engine 124 may conclude that the template is not as precise as the template should be, and the template may be disqualified from further use.

In another embodiment, the determination of whether a template has performed a legitimate extraction may involve a determination of whether the template does not fail to extract from the documents of the cluster. If a particular template does fail to extract information from documents of the cluster, then information extraction engine 124 may conclude the template is not as precise as the template should be, and the template may be disqualified from further use.

After a new template is generated for each cluster identified in step 2130, each new template generated in step 2160 becomes a seed template in step 2170, as shall be explained in more detail below.

### H) Automated Iteration of Template Creation

In step 1262, a determination is made as to whether there were any new templates, which have not been disqualified for further use, generated in step 2160. If there were no new templates generated in step 2160 which qualify for future use, then the process of creating templates in an automated fashion ends in step 2164. However, if there were new templates generated in step 2160 which qualify for further use, then the process of creating templates in an automated fashion continues to step 2170.

In step 2170, each new template generated in step 2160, which has not been disqualified for further use as discussed above, becomes a seed template for the cluster associated therewith. Thereafter, the process may proceed to step 2110 to begin a new iteration of the process. In this way, the process may run in iteration until no further templates are available or qualify for generation.

Once processing proceeds from step 2170 to step 2110, the new template generated for each cluster in step 2160 becomes a seed template for the cluster, and the new seed template for each cluster may be used to extract a different set of attributes from each document of the cluster. Thereafter, the process steps depicted of FIG. 21 may continue for each cluster. In this way, additional seed templates may be created for additional cluster as long as additional matching documents continue to be identified in step 2120.

Advantageously, powered by a very small number of manual annotations performed during step 2105, embodiments can extract many more records than prior approaches, thereby reducing the cost per extracted record. Hence, embodiments of the invention may be employed to make data extraction from a large amount of documents, such as web pages on the World Wide Web, far more scalable than any prior approach.

### Hardware Overview

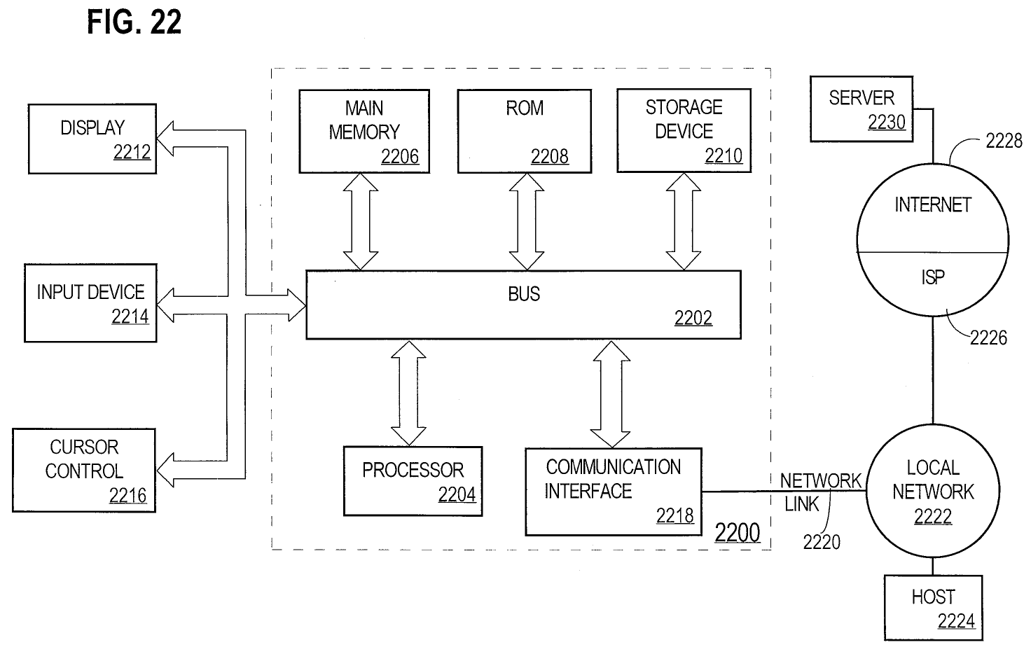

FIG. 22 is a block diagram that illustrates a computer system 2200 upon which an embodiment of the invention may be implemented. Computer system 2200 includes a bus 2202 or other communication mechanism for communicating information, and a processor 2204 coupled with bus 2202 for processing information. Computer system 2200 also includes a main memory 2206, such as a random access memory (RAM) or other dynamic storage device, coupled to bus 2202 for storing information and instructions to be executed by processor 2204. Main memory 2206 also may be used for storing temporary variables or other intermediate information during execution of instructions to be executed by processor 2204. Computer system 2200 further includes a read only memory (ROM) 2208 or other static storage device coupled to bus 2202 for storing static information and instructions for processor 2204. A storage device 2210, such as a magnetic disk or optical disk, is provided and coupled to bus 2202 for storing information and instructions.

Computer system 2200 may be coupled via bus 2202 to a display 2212, such as a cathode ray tube (CRT), for displaying information to a computer user. An input device 2214, including alphanumeric and other keys, is coupled to bus 2202 for communicating information and command selections to processor 2204. Another type of user input device is cursor control 2216, such as a mouse, a trackball, or cursor direction keys for communicating direction information and command selections to processor 2204 and for controlling cursor movement on display 2212. This input device typically has two degrees of freedom in two axes, a first axis (e.g., x) and a second axis (e.g., y), that allows the device to specify positions in a plane.

The invention is related to the use of computer system 2200 for implementing the techniques described herein. According to one embodiment of the invention, those techniques are performed by computer system 2200 in response to processor 2204 executing one or more sequences of one or more instructions contained in main memory 2206. Such instructions may be read into main memory 2206 from another machine-readable medium, such as storage device 2210. Execution of the sequences of instructions contained in main memory 2206 causes processor 2204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 2200, various machine-readable media are involved, for example, in providing instructions to processor 2204 for execution. Such a medium may take many forms, including but not limited to storage media and transmission media. Storage media includes both non-volatile media and volatile media. Non-volatile media includes, for example, optical or magnetic disks, such as storage device 2210. Volatile media includes dynamic memory, such as main memory 2206. Transmission media includes coaxial cables, copper wire and fiber optics, including the wires that comprise bus 2202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 2204 for execution. For example, the instructions may initially be carried on a magnetic disk of a remote computer. The remote computer can load the instructions into its dynamic memory and send the instructions over a telephone line using a modem. A modem local to computer system 2200 can receive the data on the telephone line and use an infra-red transmitter to convert the data to an infra-red signal. An infra-red detector can receive the data carried in the infra-red signal and appropriate circuitry can place the data on bus 2202. Bus 2202 carries the data to main memory 2206, from which processor 2204 retrieves and executes the instructions. The instructions received by main memory 2206 may optionally be stored on storage device 2210 either before or after execution by processor 2204.

Computer system 2200 also includes a communication interface 2221 coupled to bus 2202. Communication interface 2221 provides a two-way data communication coupling to a network link 2220 that is connected to a local network 2222. For example, communication interface 2221 may be an integrated services digital network (ISDN) card or a modem to provide a data communication connection to a corresponding type of telephone line. As another example, communication interface 2221 may be a local area network (LAN) card to provide a data communication connection to a compatible LAN. Wireless links may also be implemented. In any such implementation, communication interface 2221 sends and receives electrical, electromagnetic or optical signals that carry digital data streams representing various types of information.

Network link 2220 typically provides data communication through one or more networks to other data devices. For example, network link 2220 may provide a connection through local network 2222 to a host computer 2224 or to data equipment operated by an Internet Service Provider (ISP) 2226. ISP 2226 in turn provides data communication services through the world wide packet data communication network now commonly referred to as the “Internet”2228. Local network 2222 and Internet 2228 both use electrical, electromagnetic or optical signals that carry digital data streams. The signals through the various networks and the signals on network link 2220 and through communication interface 2221, which carry the digital data to and from computer system 2200, are exemplary forms of carrier waves transporting the information.

Computer system 2200 can send messages and receive data, including program code, through the network(s), network link 2220 and communication interface 2221. In the Internet example, a server 2230 might transmit a requested code for an application program through Internet 2228, ISP 2226, local network 2222 and communication interface 2221.

The received code may be executed by processor 2204 as it is received, and/or stored in storage device 2210, or other non-volatile storage for later execution. In this manner, computer system 2200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A method for creating templates for electronic documents, comprising:
extracting, using a first template, one or more attributes from a first document;
identifying a second document that contains a particular attribute of said one or more attributes;
annotating said second document, using said first template, to create an annotated document;
generating a new template for said annotated document, wherein said new template facilitates extraction of information from said annotated document; and
storing said new template on a volatile or non-volatile computer-readable medium.

2. The method of claim 1, wherein said second document is in a different cluster of documents than said first document.

3. The method of claim 1, wherein said annotated document is created by an automated process without human intervention.

4. The method of claim 1, wherein said step of annotating said second document comprises:
comparing content of at least one attribute of the one or more attributes extracted from the first document with content of said second document to identify locations within said second document which are desired to be extracted; and storing data that identifies the locations within said second document which are desired to be extracted.

5. The method of claim 1, wherein said second document is a web page of a web site, wherein said first document is not part of said web site, and wherein the method further comprises:
grouping a plurality of web pages, of said web site, which have similar structural characteristics into a cluster of web pages, wherein said second document is included in said cluster of web pages.

6. The method of claim 5, further comprising:
extracting, using said new template, a same set of attributes from each web page of said cluster of web pages.

7. The method of claim 1, further comprising:
identifying one or more clusters of documents, wherein at least one member from each of said one or more cluster of documents contains at least one attribute of said one or more attributes; and
identifying for which of said one or more clusters of documents a corresponding template should be generated.

8. The method of claim 7, wherein said step of identifying for which of said one or more clusters of documents a corresponding template should be generated comprises:
upon determining that a specified level of correlation exists between portions of a tree representation for documents in a particular cluster of documents of said one or more clusters of documents, determining that a particular corresponding template should be generated for said particular cluster of documents.

9. The method of claim 1, wherein the step of identifying the second document comprises using an inverted index to determine that said second document contains said particular attribute.

10. The method of claim 1, wherein the step of identifying the second document comprises using fuzzy similarity metrics to determine that said second document contains said particular attribute.

11. The method of claim 1, wherein the step of identifying the second document comprises analyzing a representation of key features of said second document to determine that said second document contains said particular attribute.

12. The method of claim 1, wherein the step of identifying the second document comprises:
loading content from said second document into a trie data structure, wherein leaf nodes of said trie data structure represent DOM nodes that contain the same content; and
determining if any leaf nodes of said trie data structure correspond to said particular attribute.

13. A machine-readable storage medium storing one or more sets of instructions, which when executed, cause:
extracting, using a first template, one or more attributes from a first document;
identifying a second document that contains a particular attribute of said one or more attributes;
annotating said second document, using said first template, to create an annotated document; and
generating a new template for said annotated document, wherein said new template facilitates extraction of information from said annotated document.

14. The machine-readable storage medium of claim 13, wherein said second document is in a different cluster of documents than said first document.

15. The machine-readable storage medium of claim 13, wherein said annotated document is created by an automated process without human intervention.

16. The machine-readable storage medium of claim 13, wherein said step of annotating said second document comprises:
comparing content of at least one attribute of the one or more attributes extracted from the first document with content of said second document to identify locations within said second document which are desired to be extracted; and
storing data that identifies the locations within said second document which are desired to be extracted.

17. The machine-readable storage medium of claim 13, wherein said second document is a web page of a web site, wherein said first document is not part of said web site, and wherein execution of said one or more sets of instructions further causes:
grouping a plurality of web pages, of said web site, which have similar structural characteristics into a cluster of web pages, wherein said second document is included in said cluster of web pages.

18. The machine-readable storage medium of claim 17, execution of said one or more sets of instructions further causes:
extracting, using said new template, a same set of attributes from each web page of said cluster of web pages.

19. The machine-readable storage medium of claim 13, execution of said one or more sets of instructions further causes:
identifying one or more clusters of documents, wherein at least one member from each of said one or more cluster of documents contains at least one attribute of said one or more attributes; and
identifying for which of said one or more clusters of documents a corresponding template should be generated.

20. The machine-readable storage medium of claim 19, wherein said step of identifying for which of said one or more clusters of documents a corresponding template should be generated comprises:
upon determining that a specified level of correlation exists between portions of a tree representation for documents in a particular cluster of documents of said one or more clusters of documents, determining that a particular corresponding template should be generated for said particular cluster of documents.

21. The machine-readable storage medium of claim 13, wherein the step of identifying the second document comprises using an inverted index to determine that said second document contains said particular attribute.

22. The machine-readable storage medium of claim 13, wherein the step of identifying the second document comprises using fuzzy similarity metrics to determine that said second document contains said particular attribute.

23. The machine-readable storage medium of claim 13, wherein the step of identifying the second document comprises analyzing a representation of key features of said second document to determine that said second document contains said particular attribute.

24. The machine-readable storage medium of claim 13, wherein the step of identifying the second document comprises:
loading content from said second document into a trie data structure, wherein leaf nodes of said trie data structure represent DOM nodes that contain the same content; and
determining if any leaf nodes of said trie data structure correspond to said particular attribute.
